(19) United States
(12) Patent Application Publication
(10) Pub. No.: US 2019/0128829 A1
(43) Pub. Date: May 2, 2019

(54) Carbon Nanotube-Based Device for Sensing Molecular Interaction

(71) Applicant: Thermo Electron Scientific Instruments LLC, Madison, WI (US)

(72) Inventors: Matthew Wayne Meyer, Madison, WI (US); Nathaniel S. Safron, Madison, WI (US); Francis J. Deck, Madison, WI (US); Amirfarshad Mashal, Middleton, WI (US)

(21) Appl. No.: 16/155,955

(22) Filed: Oct. 10, 2018

Related U.S. Application Data
(60) Provisional application No. 62/570,239, filed on Oct. 10, 2017.

(51) Int. Cl. G01N 27/12; C01B 32/162

(52) U.S. Cl. CPC G01N 27/127; C01B 2202/02; C01B 32/162

(57) ABSTRACT

Devices and methods are disclosed having (a) an exposed semiconducting single walled carbon nanotube channel on the surface of a substrate, wherein the exposed semiconducting single walled carbon nanotube channel is functionalized with a capture moiety cognate to a target analyte, (b) a source electrode and a drain electrode connecting opposite ends of the exposed semiconducting single walled carbon nanotube channel, and (c) wherein the source electrode and the drain electrode are electrically connected in a manner to detect changes in current through the exposed semiconducting single walled carbon nanotube channel in response to analyte in contact therewith,

### RELATED APPLICATIONS

This application claims priority to U.S. Provisional Application Ser. No. 62/570,239, filed Oct. 10, 2017, and entitled “CARBON NANOTUBE-BASED DEVICE FOR SENSING MOLECULAR INTERACTION”, which is herein incorporated by reference herein in its entirety.

### FIELD OF THE INVENTION

The present invention relates to devices and methods for making devices for the sensing of molecular interactions using a functionalized carbon nanotube substrate to measure changes in conductance.

### BACKGROUND OF THE INVENTION

Carbon nanotube devices are known. See U.S. Pat. Nos. 7,416,699, 6,528,020, and 7,166,325. However, carbon nanotube devices may not operate at a level of sensitivity needed for analysis of biomolecules, such as in a biological sample. A need therefore exists for the development of a carbon nanotube-based device having the sensitivity to sense biomolecules, such as in a biological sample.

### SUMMARY

Aspects of the present disclosure are directed to devices using a functionalized carbon nanotube substrate for detecting conductance in response to a molecular interaction with the functionalized carbon nanotube substrate. According to one aspect, a carbon nanotube substrate is characterized by high surface area and semiconducting properties that allow for molecular interactions to be detected due to a change in conductance of the carbon nanotube substrate. According to one aspect, the carbon nanotube substrate is fabricated onto a support using methods known to those of skill in the art to produce a carbon nanotube substrate that can generate changes in conductance due to interaction of a target analyte with the carbon nanotube substrate, such as a biomolecule. Such carbon nanotube substrates are characterized by sufficient nanotube alignment to generate conductance. According to one aspect, the carbon nanotube substrate has a high degree, i.e. greater than 85%, greater than 90%, greater than 95%, greater than 96%, greater than 97%, greater than 98%, or greater than 99% of carbon nanotube alignment. According to one aspect, the carbon nanotube substrate has a high density of carbon nanotube alignment. The carbon nanotube substrate is characterized by a reduced tube-to-tube contact resistance resulting in a high conductivity that supports the detection of a target analyte having a concentration in a sample in at least the femtomolar range.

Methods of making such a carbon nanotube substrate on a support include spin coating or continuous, floating evaporative assembly as is known in the art. Such a carbon nanotube substrate is fashioned into a transistor having a large on-conductance per width and a large on/off ratio. According to one aspect, the carbon nanotube substrate may be fashioned using photolithographic techniques into a biosensor, insofar as the analyte to be detected is a biomolecule in a biological sample.

According to one aspect, the present disclosure provides a biosensor device for label-free sensing based on a field effect transistor (FET) device including the carbon nanotube substrate having conductance as described herein. In an exemplary aspect, this transistor is made up of two terminals, the source and the drain, and a gate that controls the resistance of the device. The device relating to bio-sensing applications includes in one aspect a carbon nanotube substrate where the carbon nanotubes are aligned and are not randomly oriented. The carbon nanotube substrate is functionalized with one or more capture molecule species cognate to target analyte molecules, i.e. that have affinity to one or more target analyte molecule species. The capture molecules can be covalently bound to the carbon nanotube substrate directly or through a suitable linker. The capture molecules can be noncovalently bound to the carbon nanotube substrate directly or through a suitable linker. The capture molecules can bind to target biomolecules, such as via protein-protein interactions, hybridization or other interactions known to those of skill in the art.

Further features and advantages of certain embodiments of the present disclosure will become more fully apparent in the following description of the embodiments and drawings thereof, and from the claims. According to representative methods, one or more conventional steps, such as those associated with sample preparation, may be simplified or even omitted.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The foregoing and other features and advantages of the present embodiments will be more fully understood from the following detailed description of illustrative embodiments taken in conjunction with the accompanying drawings in which:

FIG. 1 is a comparison of the dynamic range of conductance for graphene illustrated as line 110 and carbon nanotubes illustrated as line 120.

FIG. 2A is a schematic illustrating various method steps of embodiments of the present disclosure.

FIG. 2B is a schematic illustrating various method steps of an alternative embodiment of the present disclosure.

FIG. 3 is an illustration of a mask designed to create a plurality of electrical devices 100 fabricated on a single large support.

FIG. 4 is an illustration of various embodiments of covalent or non-covalent attachment of a carboxyl group to a carbon nanotube.

FIG. 5 depicts a line 510 representing a Raman spectrum of s-SWCNTs on SiO2 without treatment of 1-pyrene butanoic succinimidyl ester and fluorescently tagged amino quantum dots attached to the surface. FIG. 5 also shows line 520 depicting a Raman spectrum of s-SWCNTs on SiO2 with treatment of 1-pyrene butanoic succinimidyl ester and fluorescently tagged amino quantum dots attached to the surface.

FIG. 6 depicts contact angle measurement of a water droplet after pyrene butyric acid treatment of carbon nanotubes.

FIG. 7 depicts attachment of proteins adsorbed on the carbon surface of a biosensor device as described herein where protein adsorption beyond the Debye layer goes undetected.

FIGS. 8A-D are directed to current measurement of various embodiments described herein.

FIG. 9 depicts a circuit diagram of the present disclosure and, in particular shows a schematic of a single analog Source Measurement Unit (SMU) used to source and measure current.

FIG. 10 depicts data of the association and dissociation of Rabbit IgG.

FIG. 11 is a plot of background subtraction in FIG. 10.

FIG. 12 is an illustration of a shadow mask used to produce a sensor device having a palladium source and a palladium drain connecting carbon nanotube channels.

FIG. 13 is a schematic representation of bonding of the sensor device to a probe and encapsulation of the electrical connections to the probe.

FIG. 14 depicts gate voltage versus conductance for devices as described herein.

FIG. 15 is an illustration depicting a sensor device operationally mounted to a probe, wherein the probe delivers the sensor device into a well containing a sample for analysis.

FIG. 16 is an illustration depicting an exemplary mechanical design for interfacing the TO header having three wire leads to a female socket.

FIG. 17 depicts an embodiment of the use of an ejector pin to force the TO-header to which the sensor device is attached from the female socket.

FIG. 18 depicts various interrelated and interconnected components of a dip and read system.

FIG. 19 is an illustration depicting a TO-header attached to a horizontally oriented printed circuit board using magnets with the sensor device mounted on the bottom.

FIG. 20 is an illustration depicting connection of electrical leads of a sensor device to the electrical leads of the printed circuit board by solder bumps located below the sensor device.

FIG. 21 is an illustration depicting encapsulation around the edges between the sensor device and the printed circuit board to create a vertical biosensor.

FIG. 22 is an illustration depicting a vertically oriented sensor device design.

FIG. 23 is a schematic illustrating a connection embodiment of a sensor printed circuit board connecting to a bio-contact printed circuit board via a ring magnet with an ejector pin and 6 contact pads on the sensor board electrically connected to 6 pogo pins on the bio-contact printed circuit board.

FIG. 24 is an illustration depicting 8 sensor devices in series in a vertical configuration along a printed circuit board.

The figures should be understood to present an illustration of an embodiment of the invention and/or principles involved. As would be apparent to one of skill in the art having knowledge of the present disclosure, other devices, methods, and analytical instruments will have configurations and components determined, in part, by their specific use. Like reference numerals refer to corresponding parts throughout the several views of the drawings.

### DETAILED DESCRIPTION OF EMBODIMENTS

Aspects of the present disclosure are directed to a sensor device including a functionalized carbon nanotube substrate fashioned within a transistor environment that can detect changes in conductance when a target analyte or plurality of target analytes contact the functionalized carbon nanotube substrate. According to one aspect, a carbon nanotube wafer is created by coating the wafer with carbon nanotubes so as to produce an electrically conductive carbon nanotube substrate. Exemplary methods include a spin coated deposition process or continuous, floating evaporative self-assembly (FESA) process. One of skill is to understand that other suitable methods known to those of skill may be employed to create the electrically conductive carbon nanotube substrate. Such other methods will become apparent to those of skill based on the present disclosure.

According to certain aspects, metal electrodes are positioned on a carbon nanotube substrate so as to form a source and drain. The source and drain connect a carbon nanotube channel which is functionalized to include capture moieties for target molecules. The carbon nanotube channel is configured to contact a sample such as a biological sample. The carbon nanotube channel may be exposed so that the carbon nanotube channel can be contacted to a sample or the sample can be contacted to the carbon nanotube channel The metal electrodes are electrically connected so that differences in conductance of the carbon nanotube channel due to analyte binding may be determined. A dielectric window may be utilized on the surface of the device as described herein.

According to one aspect, metal electrodes are deposited over the carbon nanotube surface. Such deposition of a metal at desired locations or in a desired pattern can be accomplished using metal deposition methods in combination with lithographic methods known to those of skill such as shadow mask lithography or photolithography. The metal electrodes create a source and drain for the sensor device. The approximate dimensions of the wafer support for the sensor device can be flexible.

According to one aspect, the dimension of the sensor device should coincide or be useful with a probe to which the sensor device is attached. An exemplary probe may be a transistor outline (TO) header or a custom printed circuit board (PCB) having contact pads or other suitable structure for creating a probe having the sensor device attached thereto. An exemplary purpose of the probe is to direct the sensor device into contact with a sample. In one embodiment, the source electrode and the drain electrode are electrically connected to a corresponding contact pad of the probe. According to one aspect, the source and drain electrodes of the sensor device are wire bonded to the corresponding contact pads to provide a source and drain. The sensor device is then encapsulated to protect the wire bonds from the buffer or biological environment, with the carbon nanotube substrate being exposed to facilitate contact with a sample. In an additional aspect, the probe may be a printed circuit board (PCB) and the sensor device is mounted on the printed circuit board (PCB) material that can be designed to fit into a multi-well plate, such as a 96 well plate. Other well-plate configurations will become apparent to those of skill. The sensor device can be dipped into a well of a well plate with a XYZ stage or robotic arm to provide full automation for the bio-detection. Exemplary stages and robotic arms useful for embodiments described herein are known to those of skill. The sensor device as described herein may detect the presence of an analyte or be otherwise be used to measure association/dissociation kinetics or equilibrium constants.

According to one aspect, the carbon nanotube substrate includes semiconducting single walled carbon nanotubes (s-SWCNTs). Such s-SWCNTs are characterized by a high surface area and semiconducting properties sufficient to produce a scalable sensitivity. According to one aspect, the carbon nanotube substrate is planar. According to one aspect, the carbon nanotube substrate is a carbon nanotube semiconductor surface fashioned into a biosensor device that monitors electrical field charge carriers across the semiconductor materials surface. When binding events from biomolecular interactions occur and are coupled with the surface of the carbon nanotubes, the carrier concentration on the nanotube can change which changes the conductivity. As target analytes bind to the functionalized nanotube surface, the current is altered and detected. According to one aspect, the binding interaction occurs within the Debye screening length in order for the interaction to be detected. To enhance the sensitivity, small receptors such as fragmented antibodies, can be used.

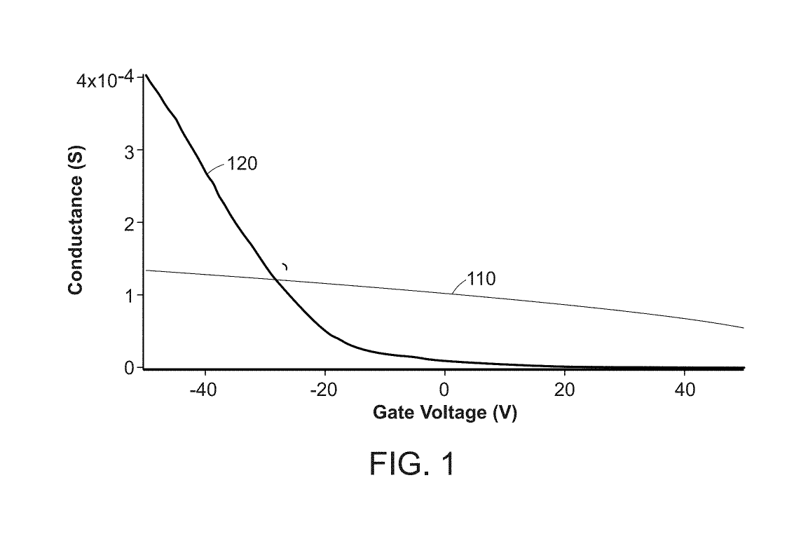

FIG. 1 is a comparison of the dynamic range of conductance for graphene illustrated as line 110 and carbon nanotubes illustrated as line 120. As indicated, the conductance modulation of the ON and OFF for the carbon nanotubes is superior to the graphene. Based on this experimental data, carbon nanotubes are estimated to be 20 times more sensitive than graphene, and accordingly, provide the substrate between electrodes for detection of target analytes.

According to certain aspects, devices of the present disclosure are fabricated using a carbon nanotube deposition technique to create the carbon nanotube substrate on a support and photolithography to create terminals or electrically conductive elements contacting the carbon nanotube substrate.

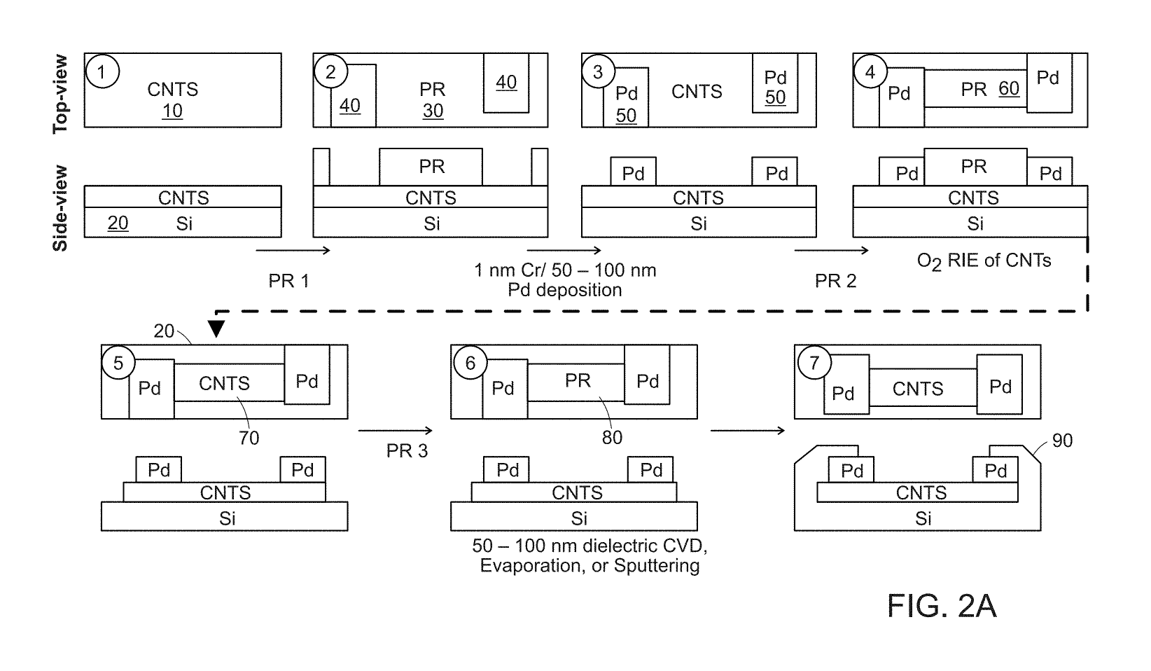

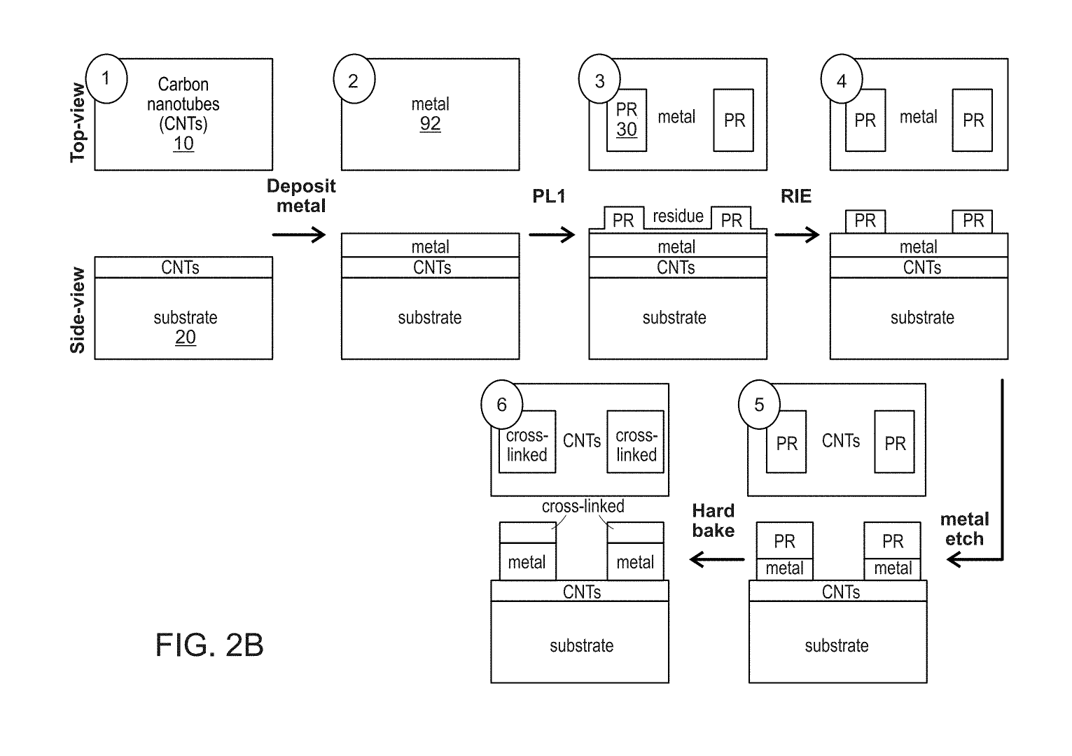

According to one aspect and with reference to FIG. 2A (step 1, top view and side view), carbon nanotubes 10 are deposited onto a support 20. According to one aspect, the support can be any support of suitable size, configuration, shape, thickness, or composition. According to one aspect, the support includes a material common to semiconductor devices such as a silicon, silicon dioxide or glass. The support may be rectangular or circular in shape and of any suitable dimension. The sensor device may have a width of between about 0.5 mm and 2.0 mm The sensor device may have a length of between about 1.5 mm and 2.5 mm An exemplary dimension is about 1.5 mm×3 mm

The carbon nanotubes are single walled carbon nanotubes known to those of skill in the art and generally used for the manufacture of carbon nanotube substrates. Carbon nanotubes (CNTs), as are known in the art, are allotropes of carbon with a generally cylindrical nanostructure. In general, carbon nanotubes are characterized by a hollow cylindrical structure of given length with the walls formed by one-atom-thick sheets of carbon, called graphene. In general, graphene sheets are rolled or otherwise configured at specific and discrete (“chiral”) angles, and the combination of the rolling angle and radius decides the nanotube properties, for example, whether the individual nanotube shell is a metal or semiconductor. Nanotubes are categorized as single-walled nanotubes (SWCNTs) and multi-walled nanotubes (MWCNTs). Individual nanotubes can naturally align themselves into “ropes” held together by van der Waals forces, more specifically, pi-stacking. Exemplary single-walled carbon nanotubes (SWCNTs) have a diameter of about 1 nanometer, but can be wider. According to one aspect, SWCNTs can exhibit a band gap from zero to about 2 eV and their electrical conductivity can show metallic or semiconducting behavior. Single-walled carbon nanotubes provide exemplary substrates for the detection devices described herein. Exemplary carbon nanotubes for use in devices are those described in U.S. Pat. Nos. 7,416,699, 6,528,020, and 7,166,325 each of which is hereby incorporated by reference in its entirety.

The carbon nanotubes may be applied to a substrate surface using methods known to those of skill in the art such as spin coating or continuous, floating evaporative assembly (FESA). Other methods of creating the carbon nanotube substrate can be readily identified by those of skill in the art based on the present disclosure.

As is known in the art, spin coating is a procedure used to deposit uniform thin films onto flat substrates. Spin coating produces a randomly orientated carbon nanotube film or network, but nonetheless may have useful conductivity for a biosensor as described herein. The thickness can be controlled by the concentration and spin speed conditions. This is a low cost and reliable production method for carbon nanotube films. It is also a versatile technique for different types of nanotubes. According to one aspect, a small amount of coating material, such as carbon nanotubes in a suitable fluid, is applied on the center of the substrate which may already be spinning or which may be at rest. The rotation of the substrate at high speed causes the coating material to spread by centrifugal force. One of skill in the art can readily identify suitable spin coater machines for spin coating the surface of a support with a coating material, such as a Laurell Technologies WS-400 spin coater, which is used to apply a coating material, such as carbon nanotubes or a photoresist material to the surface of a support. Rotation is continued while the fluid spins off the edges of the substrate, until the desired thickness of the film is achieved. The coating material typically includes an applied solvent which is usually volatile, and simultaneously evaporates. So, the higher the angular speed of spinning, the thinner the film. The thickness of the film also depends on the viscosity and concentration of the solution and the solvent. See Scriven, L E (1988). “Physics and applications of dip coating and spin coating”. MRS proceedings. 121. Spin coating can be used in photolithography, to deposit layers of photoresist about 1 micrometer thick. Photoresist is typically spun at 20 to 80 revolutions per second for 30 to 60 seconds.

As is known in the art, continuous, floating evaporative self-assembly (FESA) is a method that can be used to produce aligned carbon nanotubes. The FESA method produces aligned carbon nanotubes and has high conductivity along the aligned direction. The high conductivity comes from a reduced tube-to-tube contact resistance. This allows the biosensor to exhibit exemplary limits of detection of protein interactions such as femtomolar concentration levels, which are clinically relevant for biomarker screening. The FESA method provides a higher surface density of carbon nanotubes compared to the spin coating method, and thus can have higher sensitivity.

Continuous, floating evaporative self-assembly is an exemplary method which was used to make devices described with reference to FIG. 2A, step one. An exemplary method for purposes of the present disclosure is described in U.S. Pat. No. 9,425,405, the teachings of which are hereby incorporated by reference in its entirety. In general, SWCNs are deposited from a thin layer of organic solvent containing solubilized SWCNTs that is continuously supplied to the surface of an aqueous medium on a solid support, which induces evaporative self-assembly upon contacting the solid support. The resulting film or coating of SWCNTs is characterized by a high degree of nanotube alignment.

As is known in the art, a layer of aligned SWCNTs may be produced on a support by partially submerging a hydrophobic support in an aqueous medium. A continuous flow of a liquid solution is supplied to the aqueous medium. The liquid solution may include semiconductor-selective-polymer-wrapped s-SWCNTs dispersed in an organic solvent. The liquid solution spreads into a layer on the aqueous medium at an air-liquid interface and semiconductor-selective-polymer-wrapped s-SWCNTs from the layer are deposited as a film of aligned semiconductor-selective-polymer-wrapped s-SWCNTs on the hydrophobic substrate. The organic solvent in the layer, which is continuously evaporating, is also continuously resupplied by the flow of liquid solution during the formation of the film. The hydrophobic substrate is withdrawn from the aqueous medium, such that the film of aligned semiconductor-selective-polymer-wrapped s-SWCNTs is grown along the length of the hydrophobic substrate as it is withdrawn from the aqueous medium.

An embodiment of a film comprising aligned s-SWCNTs can be characterized in that the s-SWCNTs in the film have a degree of alignment of about ±20° standard deviation or better and the single-walled carbon nanotube linear packing density in the film is at least 40 single-walled carbon nanotubes/pm. The packing density may be defined as the number of tubes per length perpendicular to the alignment direction. In some embodiments, the films have a semiconducting single walled carbon nanotube purity level of at least 66%. In some embodiments, the films have a semiconducting single walled carbon nanotube purity level of at least 99.9%.

According to one aspect, after preparation of the SWCNT layer or substrate, the SWCNT substrate can be surface treated with an agent or combination of agents to improve the photolithographic process. Exemplary surface treatment agents include pyrene carboxylic acid, pyrene acetic acid, pyrene butyric acid, pyrene butanol, pyrene methanol, pyrene butyric PEG(X) acid, and pyrene PEG(X) acid, where X represents the number of poly ethylene glycol groups, and the like. According to one aspect, polymethyl glutarimide (PMGI) is deposited on the SWCNT substrate produced by either spin coating or FESA. PMGI provides desirable properties to improve photolithographic processes for fabricating contacts without leaving residue on carbon nanotube devices. If the thickness of the carbon nanotubes is too great, the hydrophobicity of the carbon nanotubes will prevent the PMGI from sticking to the surface. In this case, a self-assembled monolayer of pyrene butyric acid (PBA) is used to make the surface more hydrophobic so the PMGI can stick to the surface. Exemplary surface treatment agents include pyrene carboxylic acid, pyrene acetic acid, pyrene butyric acid, pyrene butanol, pyrene methanol, pyrene butyric PEG(X) acid, and pyrene PEG(X) acid, where X represents the number of poly ethylene glycol groups and the like.

According to one aspect, lithographic methods may be used to create features of the sensor device, such as electrodes, electrical connections, coatings, layers, etc., as is known in the art and as described herein. According to one aspect, metal electrodes are deposited over the carbon nanotube surface to create a source and drain between a carbon nanotube surface. The metal electrodes may be created using methods known to those of skill in the art such as lithography or lithographic methods, which may include shadow mask lithography or photolithography. As shown in FIG. 2A (step 2), a layer of a photoresist 30 is deposited onto the carbon nanotube substrate and photolithography is carried out to remove the photoresist above desired locations on the carbon nanotube substrate, thereby leaving one or more exposed regions 40 of the carbon nanotube substrate or a pattern of the carbon nanotube channel. In step 2, two exposed regions 40 are shown within a layer of photoresist 30.

Various photoresist materials and photolithography methods are known to those of skill in the art for creating a layer that then can be removed in selective regions. Photolithography, also termed optical lithography or UV lithography, is a process used in microfabrication to pattern parts of a thin film or the bulk of a substrate. In general, a layer of a photoactive material is placed onto a support. Light is then used to chemically modify the photoactive material, which is then removed. In one sense, light is used to transfer a geometric pattern from a photomask to a light-sensitive chemical “photoresist”, or simply “resist,” on the substrate. One or more or a series of chemical treatments can then be used to remove the photoresist to the reveal the material underneath the photoresist. The process can result in a pattern of removed material at desired locations that can be further processed such as by depositing desired material into the desired location, and the process can be repeated many times to produce many layers having desired regions removed and further processed.

The support can be covered with photoresist by spin coating. A viscous, liquid solution of photoresist is dispensed onto the substrate or support, and the substrate or support is spun rapidly to produce a uniformly thick layer as is known in the art. The spin coating typically runs at 1200 to 4800 rpm for 30 to 60 seconds, and produces a layer between 0.5 and 2.5 micrometers thick. The photo resist-coated support is then prebaked to drive off excess photoresist solvent, typically at 90° C. to 100° C. for 30 to 60 seconds using a heat source.

Various photoresist materials are known to those of skill in the art and are generally used to form a patterned coating on a substrate or support. In general, a photoresist is applied to a support. The photoresist is exposed to ultraviolet rays. According to one aspect, the photoresist exposed to the ultraviolet rays is then removed. According to one aspect, the photoresist not exposed to the ultraviolet rays is then removed.

Aspects of the present disclosure may make use of a positive resist, which is a type of photoresist in which the portion of the photoresist that is exposed to light becomes soluble to the photoresist developer. The unexposed portion of the photoresist remains insoluble to the photoresist developer. An exemplary positive photoresist is a DNQ-Novolac photoresist (diazonaohthoquinone (DNQ)). DNQ-novolac resists are developed by dissolution in a basic solution (usually 0.26N tetramethylammonium hydroxide (TMAH) in water). Aspects of the present disclosure may make use of a negative photoresist, which is a type of photoresist in which the portion of the photoresist that is exposed to light becomes insoluble to the photoresist developer. The unexposed portion of the photoresist is dissolved by the photoresist developer. An exemplary negative photoresist is based on epoxy-based polymer sold under the name SU-8. Photoresists can generally be described as being a photopolymeric photoresist, a photodecomposable photoresist or a photocrosslinking photoresist as is known in the art. Light sources suitable for use with photoresists include those that emit UV or shorter wavelengths or electron beams.

Aspects of the present disclosure may use shadow mask lithography, also known as stencil lithography, as it is known in the art. Shadow mask lithography is used to fabricate patterns on the surface of a substrate using a shadow mask or a stencil with apertures corresponding to the locations where material is to be deposited on the surface of a substrate. It is generally considered a resist-less, simple, parallel lithography process, which may not involve any heat or chemical treatment of the substrates (unlike resist-based techniques). Shadow mask or stencil lithography may be used with physical vapor deposition techniques where a metal is to be deposited at a desired location on a substrate. Such metal vapor deposition techniques include thermal and electron beam physical vapor deposition, molecular beam epitaxy, sputtering, and pulsed laser deposition. The more directional the material flux is, the more accurate the pattern is transferred from the stencil to the substrate. According to one aspect, the stencil is aligned (if necessary) and fixed to a substrate. The stencil-substrate pair is placed in the evaporation/etching/ion implantation machine, and after the processing is done, the stencil is simply removed from the now patterned substrate.

As shown in FIG. 2A (step 3), a layer of metal such as chromium, palladium, titanium, gold, silver, scandium, platinum or a mixture thereof is deposited, such as by metal evaporation techniques known to those of skill in the art, at the exposed regions to form electrical contacts 50 with the carbon nanotube substrate. Useful patterned metal deposition techniques are known to those of skill in the art. Metal may be deposited into a desired pattern or at a desired location using shadow mask lithography, photolithography or other lithographic techniques known to those of skill in the art. The photoresist 30 deposited in step 2 is then removed, leaving the electrical contacts. It is to be understood that such a layer of metal can be placed wherever desired based on the desired design of the device.

As shown in FIG. 2A (step 4), a layer of photoresist is then placed between the electrical contacts to protect the carbon nanotube substrate beneath. The carbon nanotube substrate beneath the electrical contacts is also protected. The remainder of the carbon nanotube substrate is exposed.

As shown in FIG. 2A (step 5), the exposed carbon nanotube substrate is removed using methods known to those of skill in the art, such as with oxygen reactive ion etching, to reveal the support 20 beneath and to define the carbon nanotube channel 70 between the metal electrodes or contacts. The photoresist protecting the carbon nanotube substrate between the electrical contacts 50 is then removed to reveal a carbon nanotube channel 70 between the electrical contacts 50. It is to be understood that a device can be designed and fabricated with one or more or a plurality of carbon nanotube channels with associated electrical contacts, as desired and for a particular purpose.

As shown in FIG. 2A (step 6), a layer of photoresist 80 is then placed over the carbon nanotube channel between the electrical contacts to protect the carbon nanotube substrate beneath. The support remains exposed.

As shown in FIG. 2A (step 7), a layer of a dielectric material 90, such as silicon oxide or silicon nitride (Si₃N₄), is then applied over the exposed support and a portion of the electrical contacts along the perimeter of the support. Such a passivating layer is deposited by High Density Plasma Chemical Vapor Deposition (HD-PCVD) or some other method known to those of skill in the art. The layer of photoresist placed over the carbon nanotube channel between the electrical contacts as described in step 6 is then removed to reveal the carbon nanotube channel 70 between the electrical contacts 50. According to one aspect, many such devices may be fabricated on a wafer as is known in the semiconductor art. Such wafers with a plurality of devices thereon may then be cleaned and the conductivity tested before the wafers are diced. The resulting electrical device is fashioned into a biosensor as described herein.

According to one aspect, the planar carbon nanotube substrate of the device described above exhibits a number of properties useful for a biosensor, including high surface area and semiconducting properties. The biosensor is scalable with the sensitivity that is required for difficult analysis such as biomarker screening. The semiconducting properties of s-SWCNTs depend on the structure of the surface atoms. According to the present disclosure, the SWCNTs are highly sorted to extract the semiconducting portion and not the metallic portion. Exemplary s-SWCNTs are between 85% and 99% semiconducting, between 90% and 99% semiconducting, between 95% and 99% semiconducting, with 98% semiconducting being exemplary. Exemplary p-type s-SWCNT transistors of the present disclosure exhibited a mobility of between 900 cm2/V*s and 1100 cm2/V*s with 1000 cm2/V*s being exemplary. A device as described herein exhibits a resistance of 10 to 100 kΩ, which is considered acceptable for bio-measurements.

Another embodiment is shown in FIG. 2b. This embodiment starts with a carbon nanotube coated substrate 20 in step 1. Then, in step 2, a uniform metal layer 92 is deposited over the entire substrate. The metal may be Pd, Au, Cu, Al, Ti, TiN, or doped polysilicon, of other suitable metals. Photoresist 30 is deposited on top of the metal layer and photolithography is performed in step 3, patterning the photoresist into regions where the photoresist has been removed (except for a small amount of residue) and unpatterned regions where the full photoresist layer is remaining. Then, in step 4, a partial reactive ion etching (RIE) step is performed to remove photoresist residue from the patterned regions but not remove the photoresist in the unpatterned regions. The etching gas could be O2, CF4, CHF3, Ar, or a combination of different gases which are typically used to remove the photoresist. In this step, the metal layer protects the carbon nanotubes from damage or degradation from the reactive etch. Then, in step 5, a metal etch of exposed regions in the metal layer is performed to make a pattern in the metal layer. This may be a wet etch in an acid to remove the metal, but not damage the carbon nanotubes. For instance, the etchant could be FeCl3+HCl, KI+I2, HF, HF+H2O2, Buffered oxide etch, or KOH, or other suitable etchants. Finally, in step 6, there is a hardbake to cross-link the photoresist for stability to prevent the photoresist from being dissolved or partially dissolved later. This photolithography step may use a negative resist, such as SU-8, which forms an insoluble dielectric layer after the hardbake, or other suitable photoresist. The remaining metal patterns on the substrate are the source and drain electrodes to make electrical contact to the carbon nanotubes.

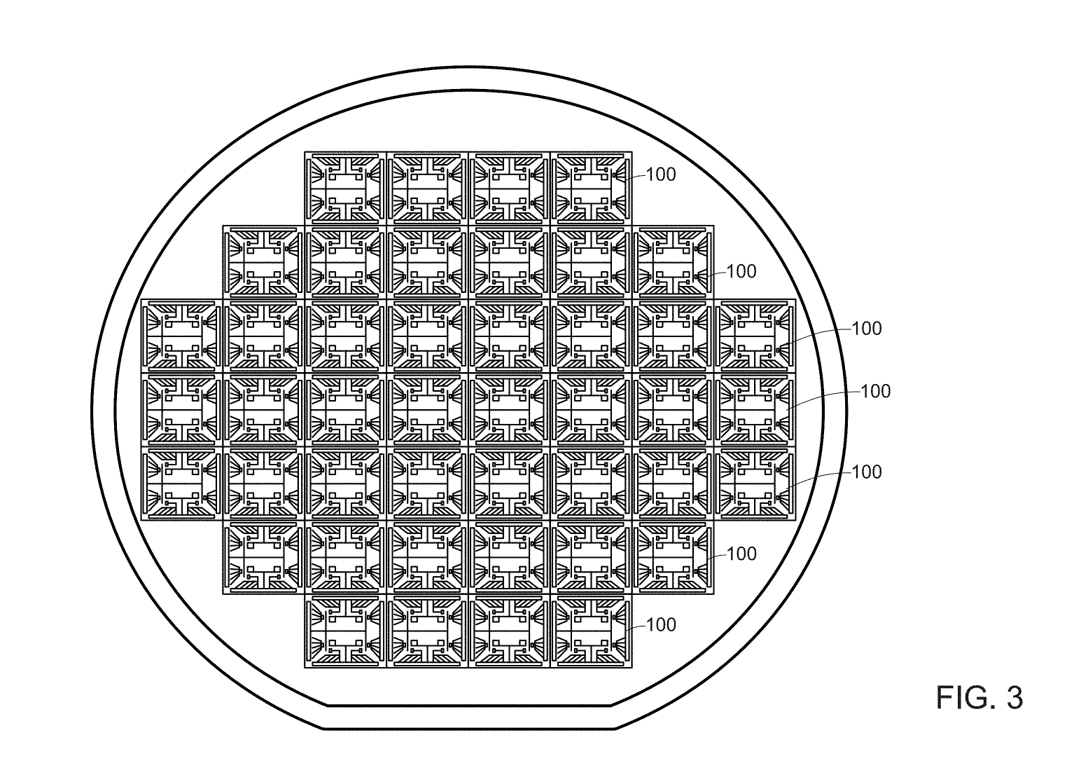

As shown in FIG. 3, a mask is designed to create a plurality of electrical devices 100 fabricated on a single large support, such as a 4 inch silicon dioxide, glass or silicon wafer, using the methods described above. It is to be appreciated that the single large support may be any desired size such as, for example, between 1 inch and 10 inches, between 2 inches and 10 inches, between 2 inches and 8 inches, such as a 6 inch silicon dioxide, glass or silicon wafer. It is to be understood that any suitable mask design can be used based on a desired biosensor design. The mask is intended to produce one or more carbon nanotube channels in any desired configuration.

According to one aspect, the carbon nanotube substrate of the electrical device can be chemically modified according to methods known to those of skill in the art including U.S. Pat. No. 8,029,734, hereby incorporated by reference in its entirety. According to one aspect, the carbon nanotube substrate including the SWCNTs is subjected to an oxidizing condition whereby oxidizing the surface of the SWCNT develops a carboxylic end group. The carboxylic group is used for further functionalization with various biomolecules such as DNA, proteins, enzymes, etc. The functionalization can be done directly on the oxidized SWCNT substrate, which is on the support.

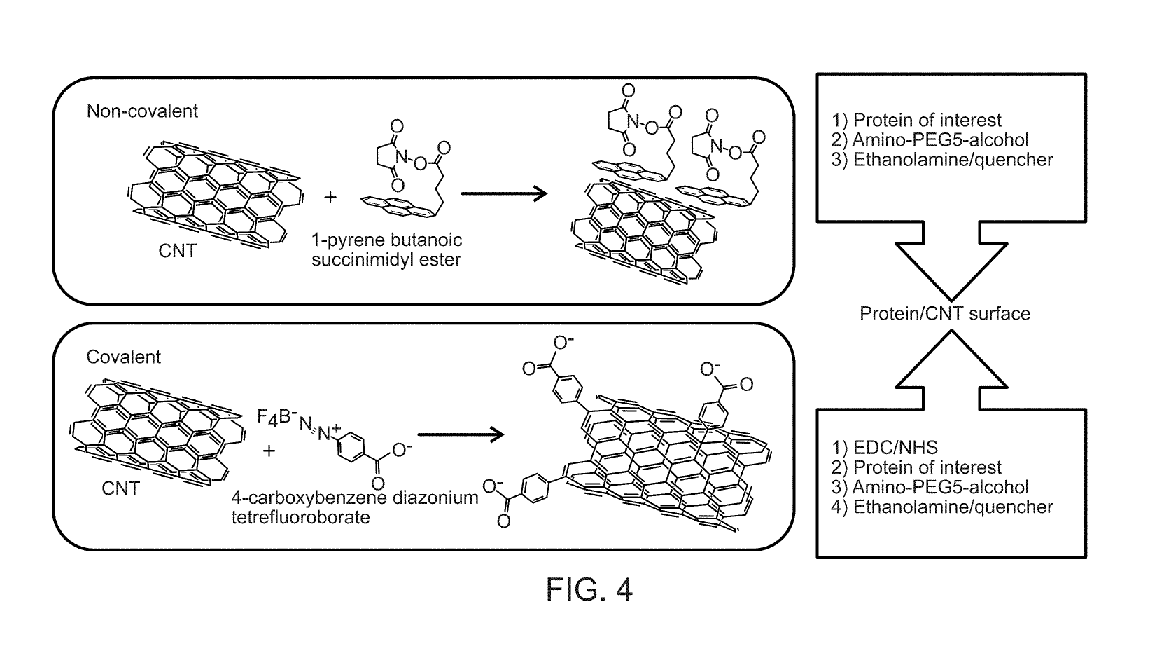

According to one aspect, after the device is made as described above with respect to FIG. 2A, a covalent or non-covalent attachment of a carboxyl group can be implemented as shown in FIG. 4. Because sp2 bonded carbon is chemically inert, the covalent attachment involves creating defects in the graphene or carbon nanotube surface so proteins can bind (sp3 sites). Covalent attachment can be done with diazonium chemistry (4-carboxybenzene diazonium tetrafluoroborate). Other exemplary covalent molecules for attaching carboxyl groups include various species of diazonium molecules, sulfuric acid, nitric acid, hydrogen peroxide, and other oxidizing compounds and the like. The non-covalent approach involves the adsorption of pyrene butyric acid or 1-pyrene butanoic succinimidyl ester via pi-pi stacking to introduce carboxyl groups. Other exemplary non-covalent molecules include pyrene carboxylic acid, pyrene acetic acid, pyrene butyric PEG(X) acid, and pyrene PEG(X) acid, where X represents the number of poly ethylene glycol groups. According to one aspect, a quantity of defects in the SWCNT surface is determined to optimize the ability of the device to detect a target analyte. It is recognized that a number of defects above a threshold may decrease the ability of the device to detect target analyte. It is recognized that a number of defects below a threshold may not create enough binding sites to detect the analyte of interest. Thresholds can be determined by those of skill in the art based on the particular application.

According to one aspect, biomolecules, such as ligands, antibodies, nucleic acids, and the like, may be immobilized on the surface of the carboxylated SWCNT substrate. The biomolecules may be referred to as functional biomolecules. Functional molecules may be linker molecules or may be capture molecules. According to one aspect, the biomolecules are used as binding partners for target analyte molecules, which may be present in a sample. According to one aspect, the biomolecules are used as a linker for a binding partner to a target analyte molecule, which may be present in a sample. The biomolecules may be attached using methods and chemistries known to those of skill in the art. According to one aspect, such biomolecules may be immobilized by 1-ethyl-3-[3-dimethylaminopropyl]carbodiimide hydrochloride (EDC) and N-Hydroxysulfosuccinimide (Sulfo-NHS) treatment in buffer. The amine groups associated with lysine residues on proteins or antibodies will displace NHS in the subsequent attachment step to form a covalent bond between the antibodies and the carbon nanotube surface through the phenolic linker. The amount of functionalization can be characterized by using amine tagged fluorescent quantum dots and characterizing with SEM and Raman imaging. Other exemplary immobilization molecules that can be attached through the carboxyl group or other means include: Protein A, Protein G, Protein L, Streptavidin, Nickel nitrilotriacetic acid, Anti-Human Fc, Anti-Human IgG, Anti-Mouse Fc, Anti-Murine IgG, Aminopropylsilane, Anti-GST, Anti-Penta-HIS, Anti-HIS and the like.

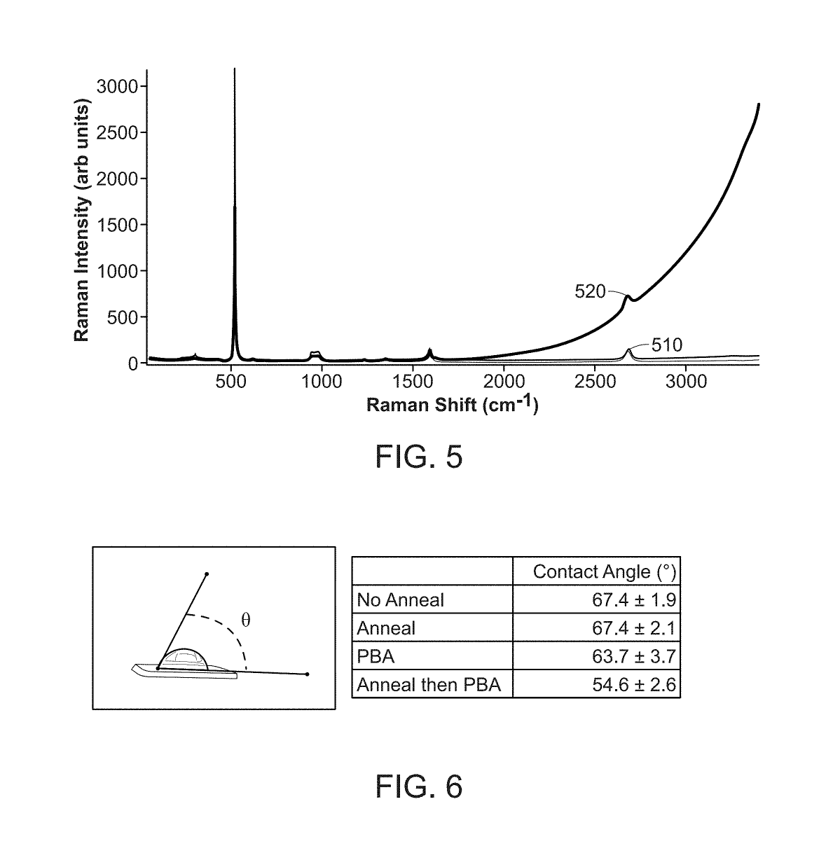

FIG. 5 shows line 510 representing a Raman spectrum of s-SWCNTs on SiO2 without treatment of 1-pyrene butanoic succinimidyl ester and fluorescently tagged amino quantum dots attached to the surface. FIG. 5 also shows line 520 representing a Raman spectrum of s-SWCNTs on SiO2 with treatment of 1-pyrene butanoic succinimidyl ester and fluorescently tagged amino quantum dots attached to the surface. The amino quantum dots react efficiently with succinimidyl esters or carboxylic acids. The quantum dots were excited with a 532 nm laser and the fluorescence emission can be seen in the Raman spectrum along with the different in-plane vibration (D) and primary in-plane vibrational mode (G peak) of the carbon nanotubes. These peaks are located at 1350 cm-1 and 1620 cm-1, respectively. The emission maximum of 655 nm was selected for the quantum dot. This type of measurement could also be used for characterizing graphene functionalization.

FIG. 6 is directed to contact angle measurement of a water droplet after pyrene butyric acid treatment of carbon nanotubes. The angle depends on hydrophobicity of the surface, which can confirm proper functionalization with the acid group facing away from the surface. The surface treatment allows thicker layers of carbon nanotubes to be used when depositing photoresist for device fabrication.

As indicated in FIG. 4, before adding the antibodies or biomolecules or interest, blocking and quenching steps can be used to help prevent non-specific binding (NSB) and increase the signal-to-noise of the measurement. Quenching generally involves adding a quenching agent such as ethanolamine to prevent downstream NSB and makes the active sites on the carbon surface unreactive. Blocking generally involves a blocking agent branched or linear molecule such as Polyethylene glycol sorbitan monolaurate (Tween-20) or polyethylene glycol (PEG). The main function of blocking is to increase the signal-to-noise of interactions occurring on the biosensor surface. Next, a functional biomolecule, such as an antibody, can be attached to the surface to function as an attachment site for a specific antigen, such as a protein, at the surface. The attachment occurs via the covalent binding of a primary amine group, i.e., —NH₂ group, for example, with NHS succinimide ester on the SWCNTs. After immobilizing the antibody or capture molecule to form the biosensor, the biosensor can be used to determine the presence of a target biomolecule, such as by contacting a biological sample to the functionalized carbon nanotube substrate. Once the target molecule is contacted to the functionalized carbon nanotube substrate and engages with the binding partner on the functionalized carbon nanotube substrate, the relative resistance change is directly related to the concentration of the target biomolecule present at the surface of the functionalized carbon nanotube substrate.

As previously described, metal evaporation through a shadow mask can be used to create source and drain electrodes through which voltage is applied and current is detected. The source and drain are typically capacitively coupled to a gate, which typically is a metal conductor. The analyte can also act as a gate if it is close to the carbon nanotubes because it contains charges or can screen charge from the metal gate. The gate is used to control the concentration of charge carriers and conductance between the source and the drain. According to one aspect of the present disclosure, the gate capacitor in the device of the present disclosure is a buffer solution or solution containing an analyte. Other examples of solutions acting as a gate capacitor include a biological sample such as blood, urine, ocular fluid, etc. The current flow between the source and drain is changed by sweeping the gate voltage. The current flow between the source and drain is changed because an analyte close to the nanotube may promote high current flow while an analyte far from the nanotube may lower the current flow, or vice versa.

The SWCNT channel length of the device, which may be referred to herein as a transistor, is between 0.1 to 500 microns. For example, the I-V characteristics of the transistors fabricated were obtained with a voltage bias (Vd) of 25 mV applied between the source electrode and the drain electrode. The drain current (Id) flowing through the SWCNTs was detected while the gate voltage (Vg) was varied from −100 mV to+100 mV. As target analytes bind to the nanotube surface, the current is altered and detected.

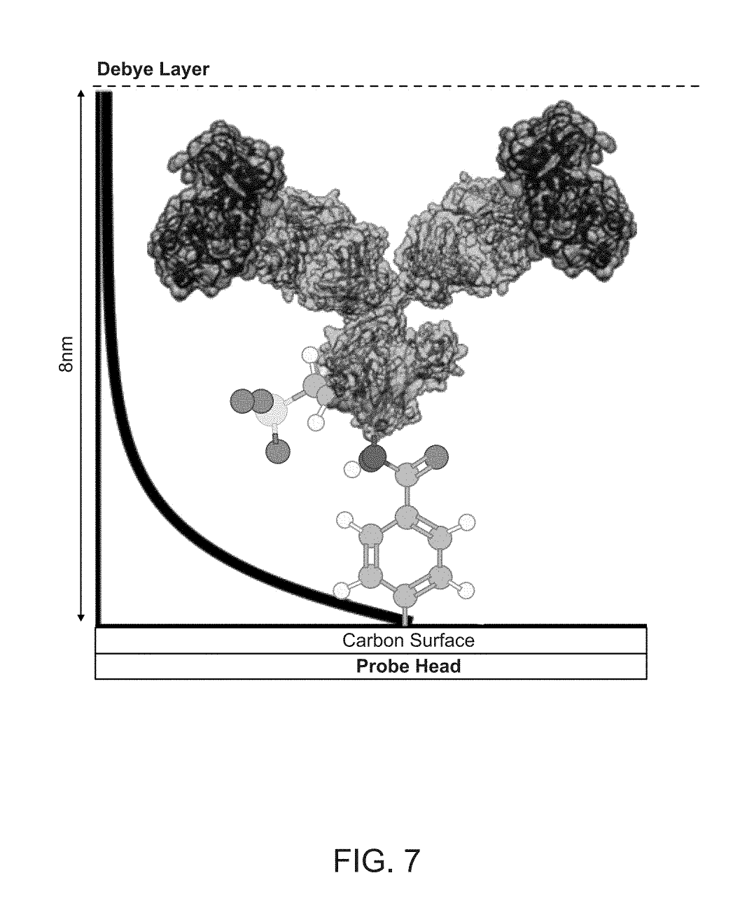

FIG. 7 is directed to the attachment of proteins adsorbed on the carbon surface of a biosensor device as described herein. Protein adsorption beyond the Debye layer goes undetected. The probe head shown in FIG. 7 may be either a transistor outline header or a printed circuit board and is intended to be a consumable device.

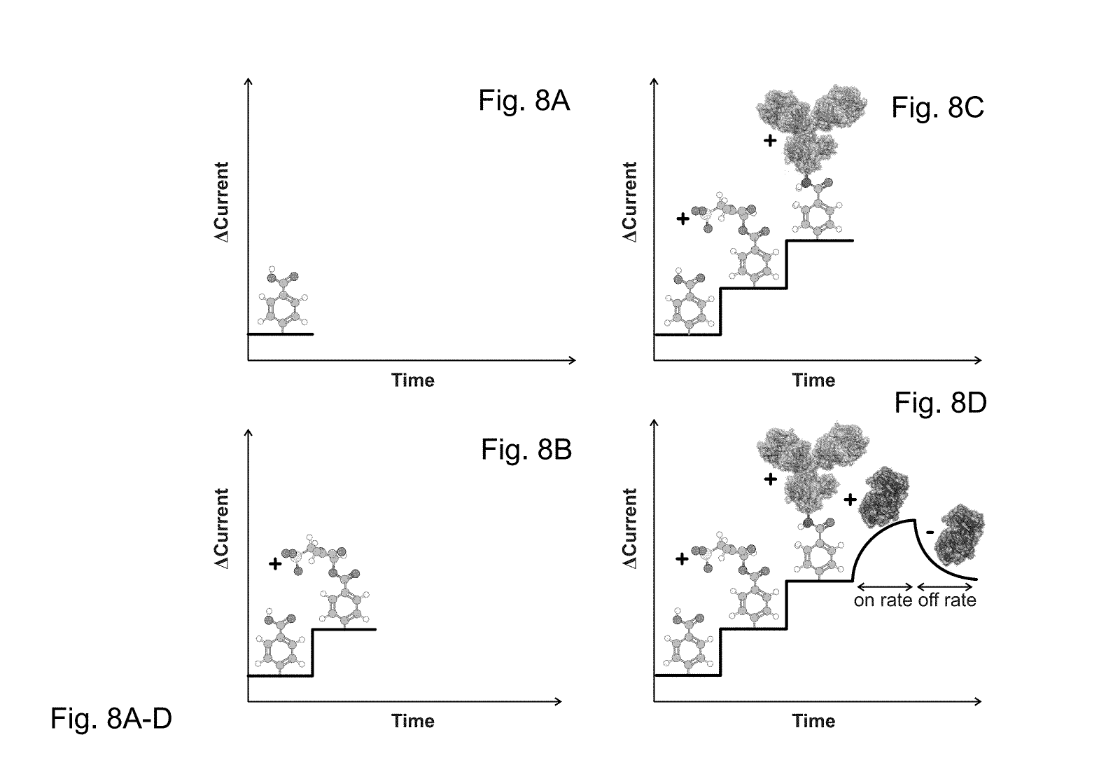

FIGS. 8A-D are directed to current measurement of various embodiments described herein. FIG. 8A depicts current measurement with a carboxyl group attached to the carbon surface. FIG. 8B depicts different current measurements with carboxyl group and EDC/NHS. FIG. 8C depicts different current measurement with an antibody or protein (i.e. biomolecule). FIG. 8D depicts different current measurement with an analyte or antigen. As indicated in FIGS. 8A-d, the different current measurements are used to determine the presence of a target analyte bound to the surface of the carbon nanotube surface of the biosensor device.

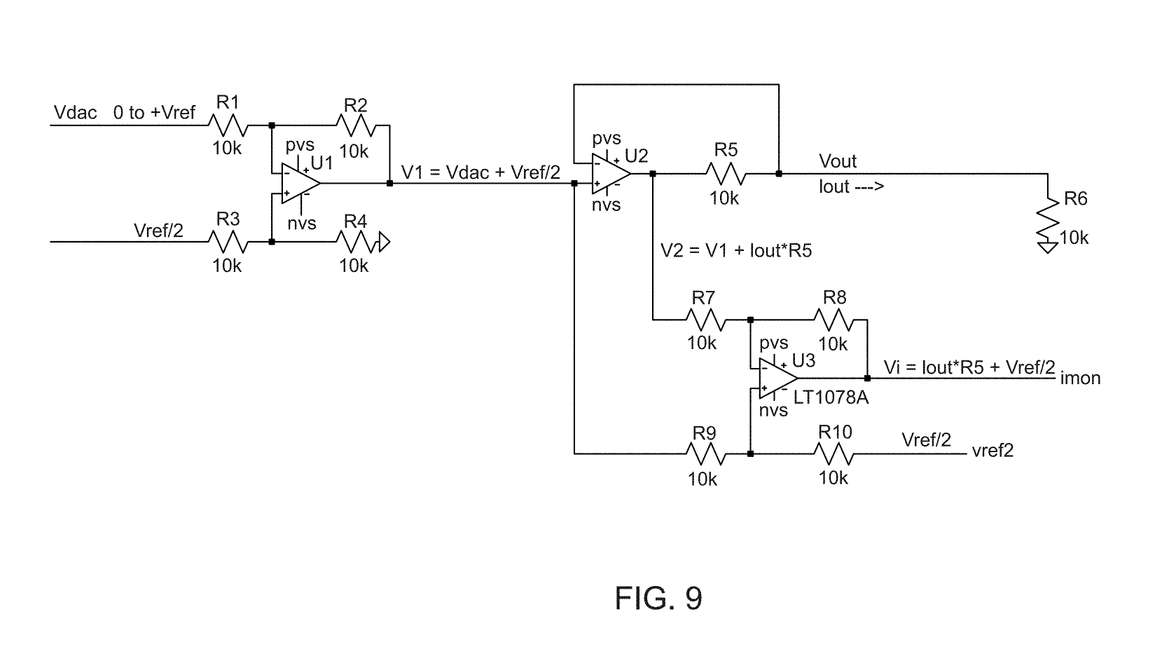

FIG. 9 is directed to depicting a circuit diagram of the present disclosure and, in particular shows a schematic of a single analog Source Measurement Unit (SMU) used to source and measure current. The pin driver is wrapped in a pair of level shifters controlled by the voltage reference Vref of the ADC and DAC. A separate circuit divides the voltage reference to provide Vref/2. T he input voltage Vdac, ranging from 0 to +Vref is shifted to the range of ±Vref. Likewise, the output current signal is shifted to a range of 0 to +Vref. The measurement hardware includes an analog to digital converter, a digital to analog converter, and a microprocessor that can be interfaced to a computer. It is to be understood that the circuit diagram is exemplary only and that other circuits represented by other circuit diagrams can be designed and used based on the present disclosure.

A person of ordinary skill in the art after reading the following disclosure will appreciate that the various aspects described herein may be embodied as a computerized method, system, device, or apparatus utilizing one or more computer program products. Accordingly, various aspects of the computerized methods, systems, devices, and apparatuses may take the form of an embodiment consisting entirely of hardware including one or more microprocessors, an embodiment consisting entirely of software, or an embodiment combining software and hardware aspects. Furthermore, various aspects of the computerized methods, systems, devices, and apparatuses may take the form of a computer program product stored by one or more non-transitory computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space). It is noted that various connections between elements are discussed herein. It is noted that these connections are general and, unless specified otherwise, may be direct or indirect, wired or wireless, and that the specification is not intended to be limiting in this respect.

### EXAMPLE I

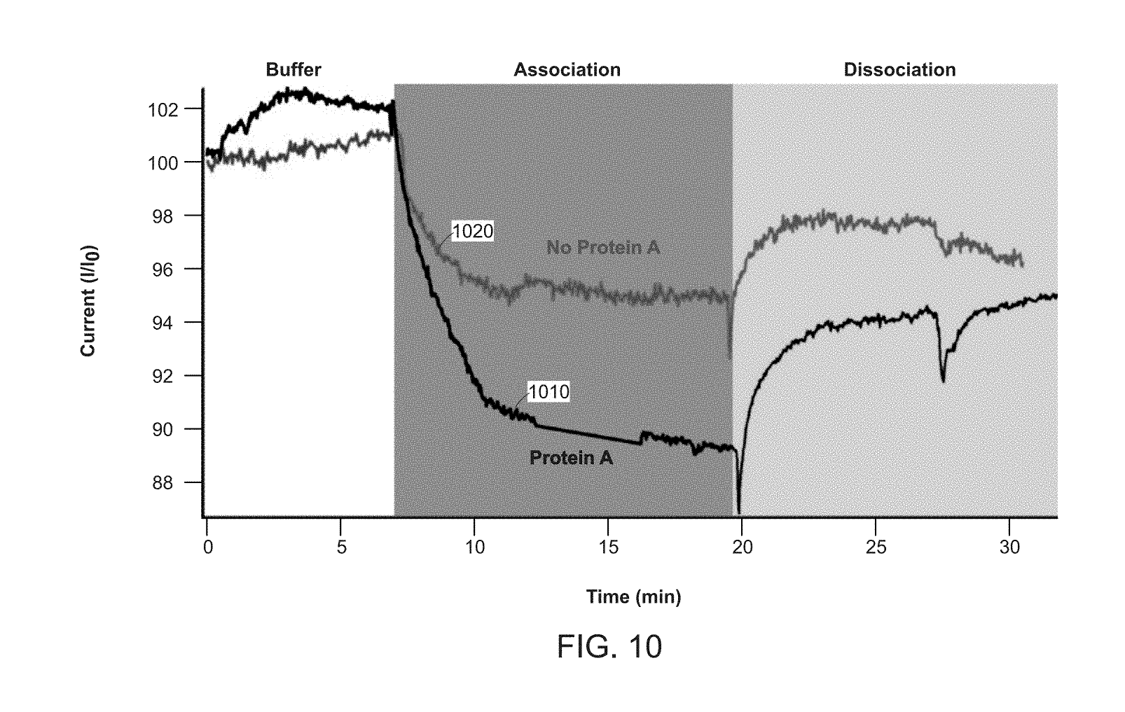

A carbon nanotube biosensor was fabricated using FESA and the photolithography methods described herein. The resulting biosensor was functionalized noncovalently with 1-pyrene butanoic succinimidyl ester. Protein A was attached to the 1-pyrene butanoic succinimidyl ester and quenched with ethanolamine. Association and dissociation of Rabbit IgG was measured and the data is presented in FIG. 10. The curve 1010 represents measuring association/dissociation of Rabbit IgG. The curve 1020 represents measurements where no Protein A was attached to the 1-pyrene butanoic succinimidyl ester.

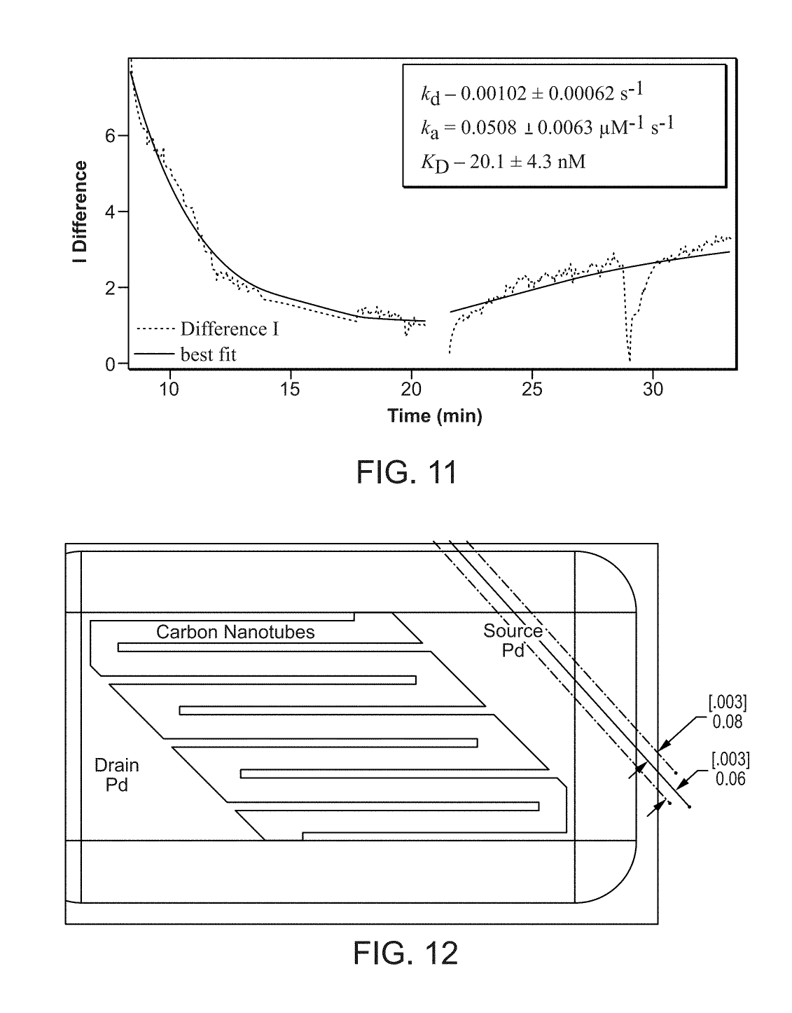

FIG. 11 is a plot of background subtraction in FIG. 10. The data was fit to a Langmuir adsorption isotherm for equilibrium protein binding where the best fit to the data yielded a two-component Langmuir equation. The kd represents a high affinity for the protein interaction.

### EXAMPLE II

A functionalized carbon nanotube biosensor was fabricated as described herein and interfaced with a probe apparatus as described herein. A shadow mask shown in FIG. 12 was used to produce a sensor device having a palladium source and a palladium drain connecting carbon nanotube channels. FIG. 12 depicts a single carbon nanotube channel having a serpentine design or configuration. A palladium source electrode and a palladium drain electrode are shown at opposite corners. Exemplary device dimensions may be 1.5 mm by 3 mm

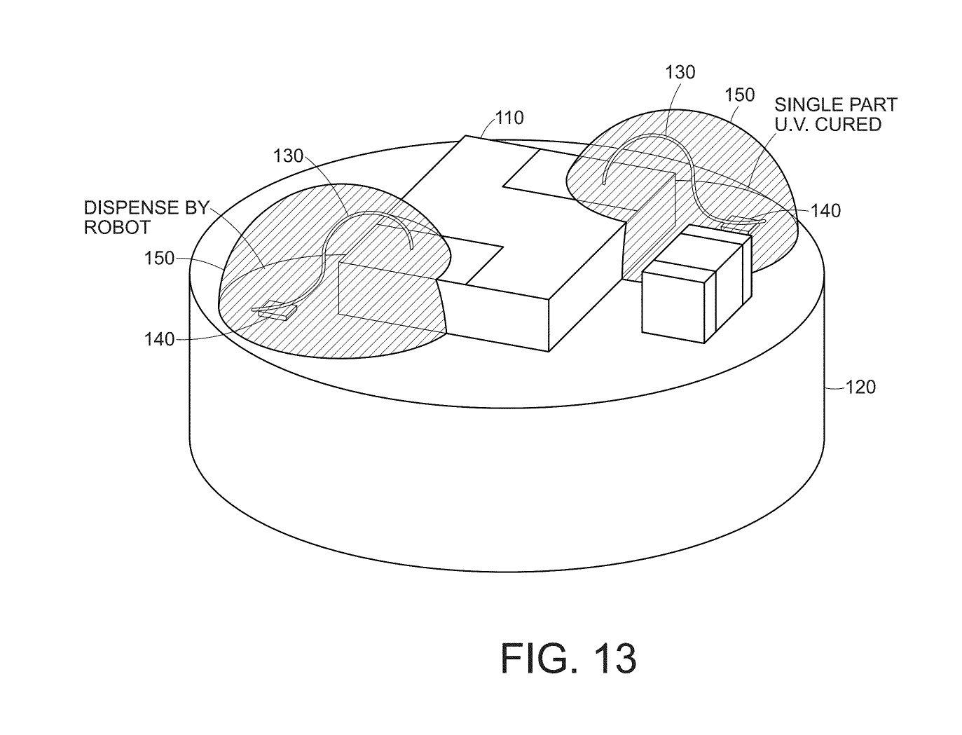

FIG. 13 is a schematic representation of bonding of the sensor device to a probe and encapsulation of the electrical connections to the probe. After completion of the shadow mask processing, the sensor device 110 (which may be referred to as a carbon nanotube transistor or a chip), is mounted to a probe 120, which may be a TO header as is known in the art (commercially available TO-46 header), such as with 3 pins. Once operationally mounted to the probe, the sensor device may be placed into a well including a sample for analysis. The chip (biosensor device) is mounted to a TO header with a UV curable epoxy or similar adhesive known to those of skill in the art and electrically connected to the TO header. Wire-bonds 130 are added that run from the metal electrodes of the chip to the contact pads 140 of the TO-header. According to one aspect, the electrical connection between the metal electrodes of the sensor device or chip and the probe (TO-header) are encapsulated, such as with UV curable epoxy or similar encapsulate known to those of skill in the art as shown at 150. According to one aspect, encapsulation is carried out such that the electrical connections are coated or encapsulated along with other features of the sensor device, however, all or a portion of the functionalized carbon nanotube substrate remains unencapsulated or uncoated so that the functionalized carbon nanotube substrate may contact a target analyte in a sample. According to one aspect, encapsulation of the electrical connection or wire bonding is important when using buffer as a liquid gate electrode. The encapsulation prevents ionic conduction between the gate and source/drain on the nanotube transistor. Encapsulation is also important to protect the electrical connection or wire bonding from physical damage.

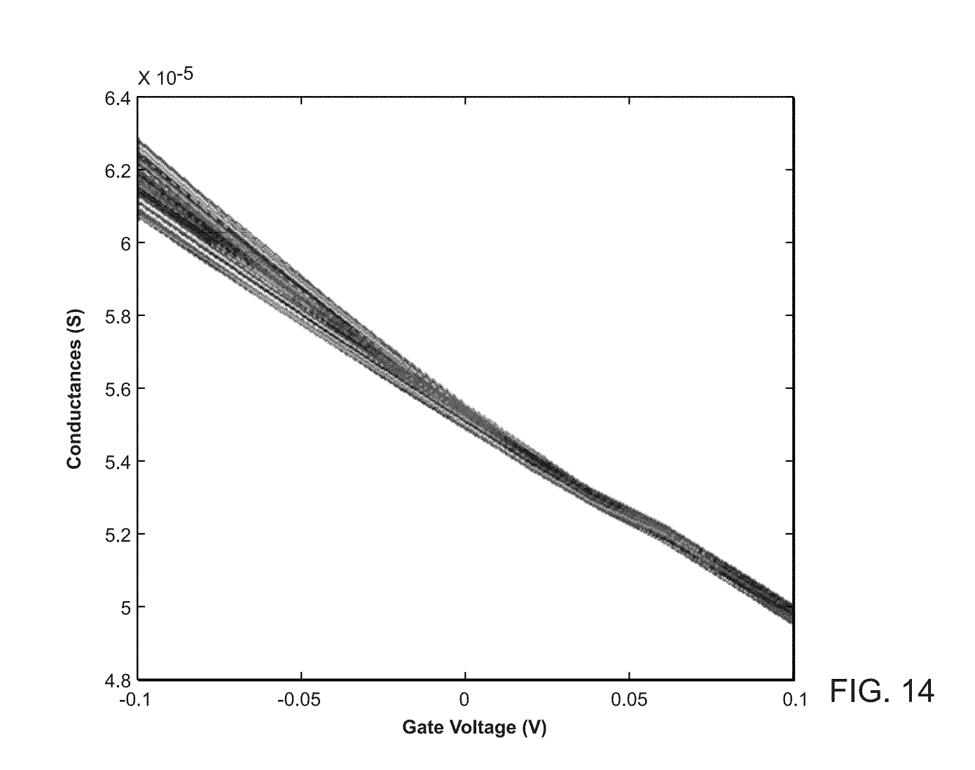

An actual sensor device made according to the methods described herein was electrically connected to a TO-46 header and where portions of the sensor device were encapsulated in a UV-cure epoxy. According to one aspect, the encapsulant may be a single part UV cured epoxy, a two part epoxy, or other epoxy or encapsulant material known to those of skill in the art. The epoxy can be dispensed by hand with a fine tip or by a robot with a programmed dispense rate and volume. The sensor devices shown in schematic in FIG. 13 and actually made were subjected to conductance measurement experiments. The gate voltage is swept from −0.1 to 0.1 volts. As shown by the data in FIG. 14, the devices show very low gate leakage and consistent transconductance measurements.

FIG. 15 depicts a sensor device 160 operationally mounted to a probe 170, wherein the probe delivers the sensor device into a well containing a sample for analysis. In this manner, samples may be prepared and delivered to wells of a well plate and the semiconducting single walled carbon nanotube biosensor may be easily and systematically contacted with a sample. The configuration shown in FIG. 15 is referred to as a “dip and read system” since the sensor device is dipped into a well plate. Accordingly, both the sensor device and the probe to which it is attached have dimensions sufficient to be placed or dipped within a well, such as a well of a commercially available well plate. The well plate can range from six to three hundred and eighty four wells or other well numbers and configurations as are known in the art and which may be commercially available.

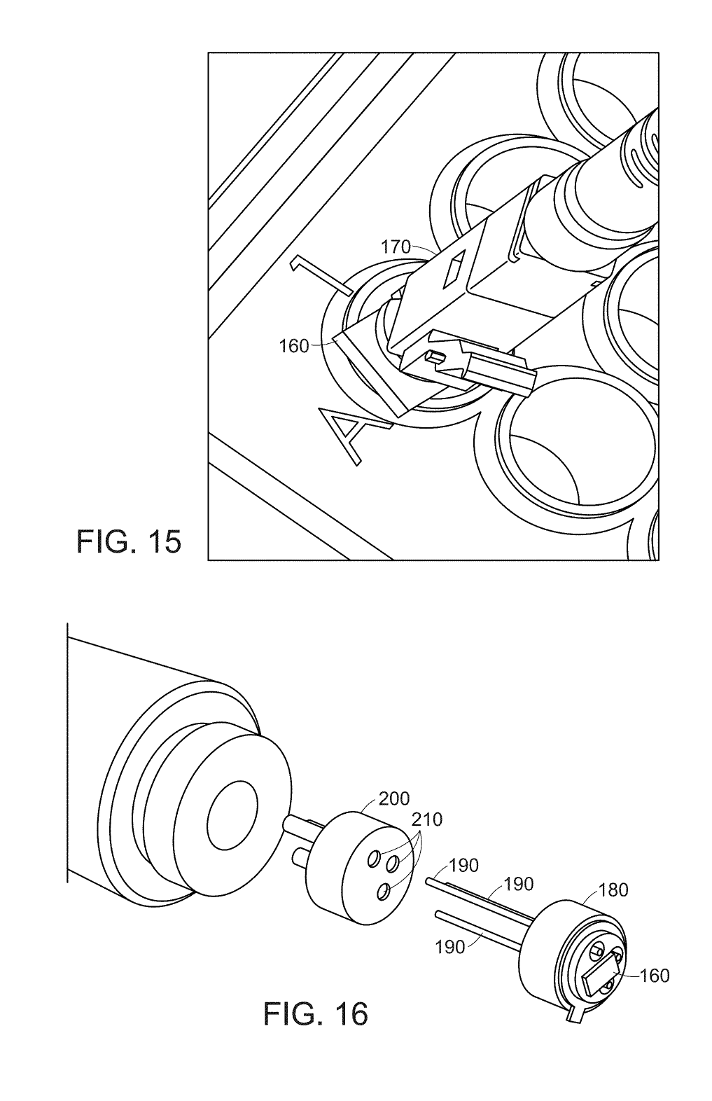

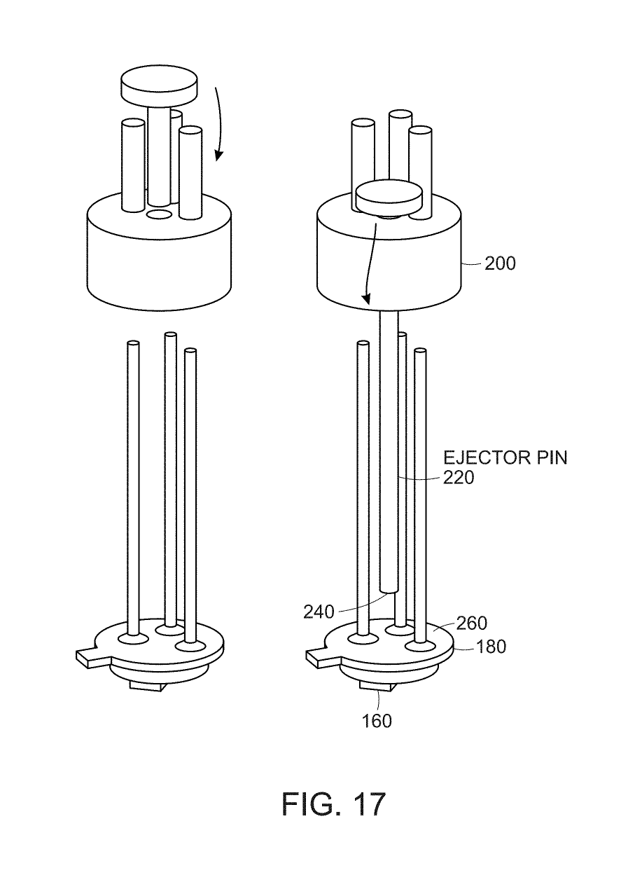

An exemplary mechanical design for interfacing the TO header 180 having three wire leads 190 to a female socket 200 is shown in FIG. 16. The sensor device is mounted as describe above with a female socket, i.e. the wire leads are removably placed within the female receiving channels 210, to allow for easy exchange of the biosensor. The biosensor is thereby removable from the probe, i.e. by withdrawing the probe from the female socket, so that it can be replaced. Since the sensor device can only be used several times, the sensor device is referred to as a consumable device. This mechanism allows for the biosensor to be easily removed from the base or probe. As an example, FIG. 17 depicts the use of an ejector pin 220 to force the TO-header 180 to which the sensor device 160 is attached from the female socket 200. The distal end 240 of the ejector pin 220 contacts the inside face 260 of the TO header 180 and force is used to push the TO header 180 and its associated wire leads away from the female socket 200. Once removed, a new TO header with a biosensor device attached can be inserted into the female socket. According to one aspect, a stepper motor can be connected to the plunger and is activated to force the plunger against the TO-header to thereby force the TO-header and the three pins away from the female socket to eject the sensor device. The use of a motor allows for automatic ejection of the sensor device from the female socket.

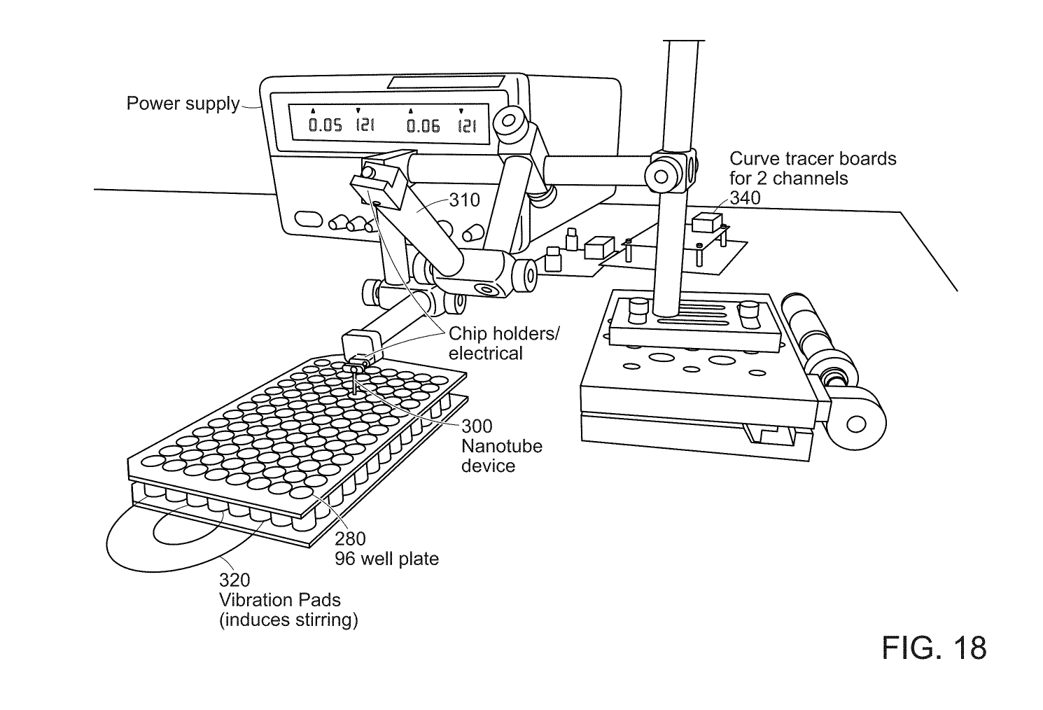

FIG. 18 depicts various interrelated and interconnected components of a dip and read system. A 96 well plate 280 is provided with a sample in one or more or all of the wells. The sensor device 300 is attached to an automated robotic arm 310 or other XYZ stage system, which translates in the X, Y and Z directions under influence of a motor to dip or place the sensor device 300 into a well, which contains a fluid sample for analysis. The well can contain buffer, water, protein solution, DNA, RNA or other biomolecule or analyte that will adsorb to the functionalized carbon nanotube surface of the sensor device. The well plate may be vibrated so as to mix the contents of the wells, such as by using a vibration pad 320 to provide a mixing effect. A curve tracer board 340 is electrically connected to the system, which has two channels for measuring a sample and a reference.

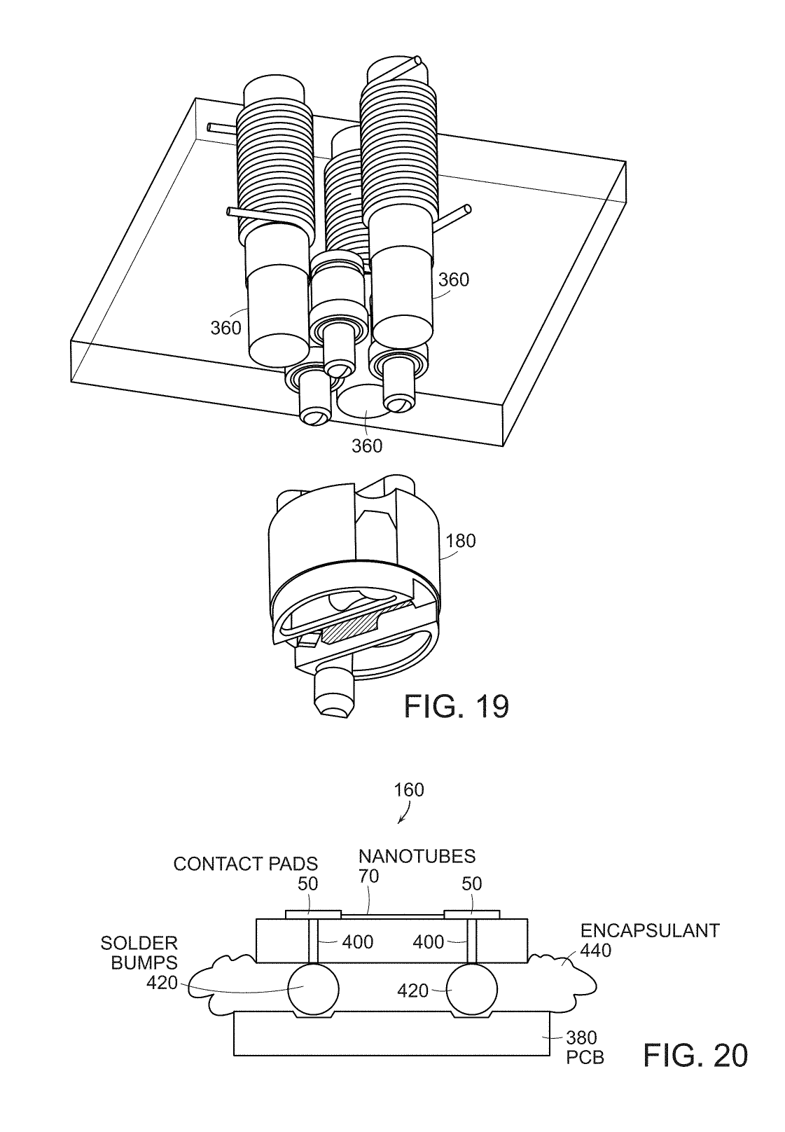

According to one aspect as depicted in FIG. 19, a TO-header 180 is attached to a horizontally oriented printed circuit board with the sensor device mounted on the bottom. The sensor device is held against a base portion by magnetics 360, such as by electromagnets. The sensor device can be released automatically from the base portion by turning off the electromagnets. According to this aspect, magnetic coils on the base portion can be used to turn magnets on or off for automatic ejection of the sensor device.

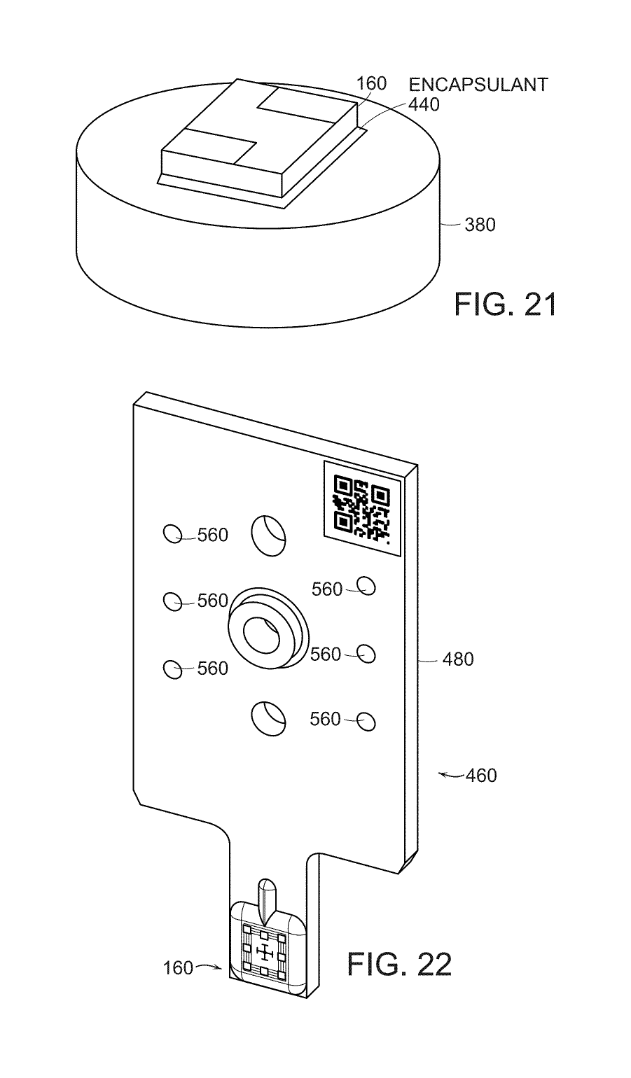

FIG. 20 shows a sensor device 160 interfaced with a printed circuit board 380 (“PCB”). The source and drain contact pads 50 and the functionalized carbon nanotube substrate 70 are on the top surface, which interacts with the external environment, which may include a sample to be analyzed. The sensor device 160 is electrically connected to the printed circuit board 380. According to one aspect, electrical leads 400 extend from the source and drain contact pads through the support and are connected to the printed circuit board. In the embodiment of FIG. 20, the electrical leads are connected to the electrical leads of the printed circuit board by solder bumps 420 located below the sensor device, although any suitable electrical connection will suffice. The electrical connection between the sensor device 160 and the printed circuit board 380 is encapsulated with an encapsulant 440. In this embodiment, the encapsulation 440 occurs around the edges between the sensor device 160 and the printed circuit board 380, which is shown in FIG. 20 and FIG. 21 to create a vertical biosensor. The vertical sensor device is then connected to a baseplate, such as with pogo pins mounted for alignment purposes. A set of magnets hold the sensors together.

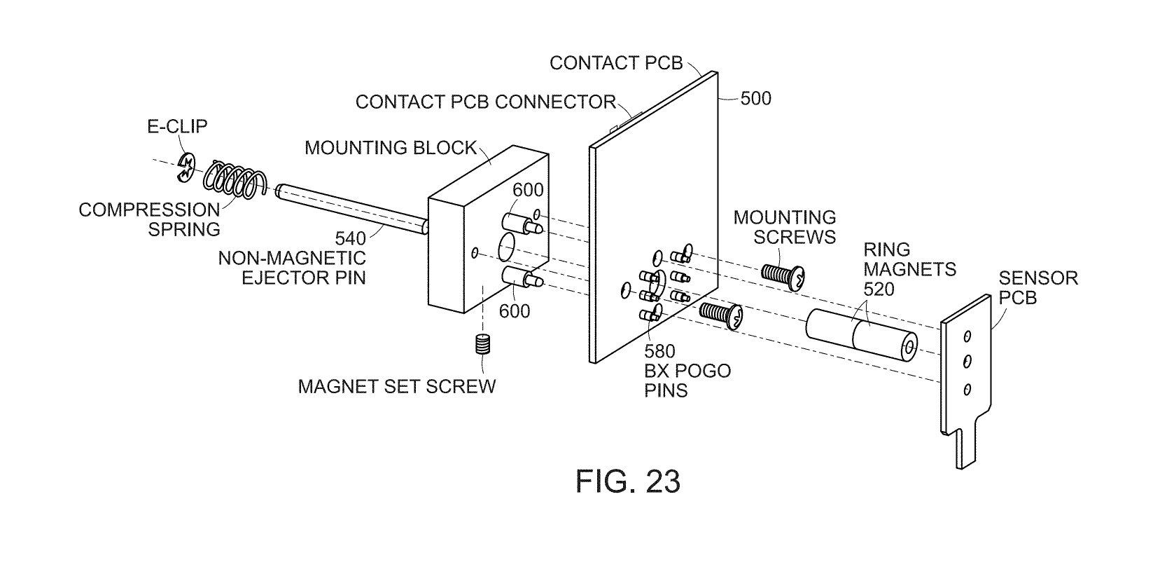

FIG. 22 depicts a vertically oriented sensor device design 460. Printed circuit boards can be made with a variety of colors, which will allow for different surface chemistries to correlate with different color printed circuit boards. The sensor PCB 480 connects with a metal spacer to the bio-contact PCB 500 shown in FIG. 23 via a ring magnet 520 with an ejector pin 540, and 6 contact pads 560 on the sensor board electrically connect to 6 pogo pins 580 on the bio-contact PCB 500. Two alignment pins 600 are used to locate the proper attachment points on the bio-contact PCB 500. For example, the approximate electromagnetic force of the magnet is 2.9 pounds and the compressive force of 6 pogo pins 580 on the bio-contact PCB is 0.9 lbs.

According to one aspect, the vertical orientation can facilitate a mixing motion in the well of the well plate insofar as the flat portion of the probe can act as a mixing paddle if vibrated or moved. The sensor device may be vibrated to cause the probe to circulate the contents of a well so as to cause a mixing motion in the well of the well plate to help facilitate stirring in the well to overcome diffusion limited binding and unbinding events.

According to one aspect, the biosensor is connected to a digital system control, which contains the source measurement unit, analog to digital converter, digital to analog converter, and microprocessor. The measurement hardware sources three different voltages and measures up to 48 different currents. The microprocessor can be interfaced to a computer.

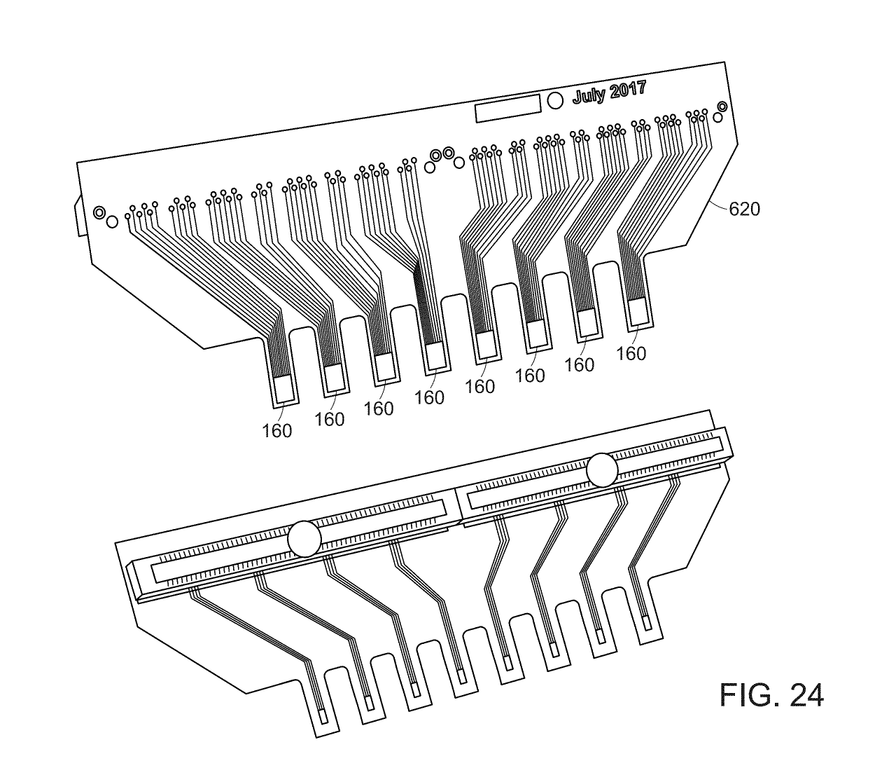

FIG. 24 depicts 8 sensor devices 160 in series in a vertical configuration along a printed circuit board 620. The sensor devices 160 can be arranged in series as two or more, three or more, four or more, five or more, six or more, seven or more, or eight or more devices as desired. A plurality of sensor devices may be arranged in series in a vertical orientation along a printed circuit board or other support device. Printed circuit board material can be configured in many different sizes and shapes. The 8 biosensors can measure 7 samples and one reference simultaneously.

### EXAMPLE III

Columns A and B of a 96 well plate are loaded with the following material:

| | A | B |
|---|---|---|
| 1 | Buffer | Buffer |
| 2 | Capture Molecule | Buffer |
| 3 | Quenching Agent | Quenching Agent |
| 4 | Blocking Agent | Blocking Agent |
| 5 | Buffer | Buffer |
| 6 | Analyte | Analyte |
| 7 | Buffer | Buffer |

The dip and read system first moves two biosensors into Row A (for the sample) and Row B (for the reference) that contains a buffer solution. Then, the probe A is moved into the second row, which contains a solution of bound molecule; while probe B is moved into more buffer. This step differentiates the two probes because one has a bound molecule on the surface. The remaining active sites are quenched in row 3 with a solution of quenching agent. The fourth step is a blocking step where the well-plate contains a solution of a blocking agent which absorbs to the surface of the carbon nanotubes, blocking non-specific binding. A calibration step is performed in row 5 in buffer solution. Row 6 contains the target analyte molecule, which can bind to the bound molecule so in this step association data is taken. Finally the probe is moved into buffer solution row 7 so that the target analyte becomes unbound and dissociation data can be taken. All of the measurements above were conducted at 25 degrees Celsius. The data in FIG. 11 was generated using this method with Protein as the capture molecule, ethanolamine as the quenching agent, Tween-20 as the blocking agent, and Rabbit IgG as the analyte.

### EXAMPLE IV

Columns A and B of a 96 well plate is load with the following material:

| | A | B |
|---|---|---|
| 1 | Buffer | Buffer |
| 2 | Capture Molecule | Capture Molecule |
| 3 | Quenching Agent | Quenching Agent |
| 4 | Blocking Agent | Blocking Agent |
| 5 | Buffer | Buffer |
| 6 | Analyte | Buffer |
| 7 | Buffer | Buffer |

The dip and read system first moves two biosensors into Row A (for the sample) and Row B (for the reference) that contains a buffer solution. After 10 minutes of incubation, both probes are moved into the second row, which contains a solution of bound molecule. The remaining active sites are quenched in row 3 with a solution of quenching agent. The fourth step is a blocking step where the well-plate contains a solution of a blocking agent, which absorbs to the surface of the carbon nanotubes, blocking non-specific binding. A calibration step is performed in row 5 in buffer solution. Row 6 contains a concentration of target analyte, which can bind to the bound molecule for probe A and buffer for probe B so in this step association data is taken. In other embodiments, more probes can be used with different concentrations of the target analyte molecule, while for the reference there is no analyte in the solution. Finally, the probe is moved into buffer solution row 7 so that the target analyte becomes unbound and dissociation data can be taken. The measurements are conducted at 25 degrees Celsius.

### EXAMPLE V

### Embodiments

Aspects of the present disclosure are directed to a method of making a biosensor device including the steps of (a) forming a semiconducting layer comprising single walled carbon nanotubes on the surface of a substrate, (b) forming a source electrode and a drain electrode connecting a single walled carbon nanotube channel, and (c) forming a dielectric window over a first portion of the source electrode and a first portion of the drain electrode while leaving a second portion of the source electrode, a second portion of the drain electrode and the single walled carbon nanotube channel exposed. According to one aspect, the semiconducting layer comprising single walled carbon nanotubes of step (a) is formed by continuous, floating evaporative self-assembly or spin coating. According to one aspect, the source electrode and drain electrode of step (b) is formed by depositing a photoresist on the surface of the semiconducting layer, photolithographically removing a portion of the photoresist to create depressions, depositing a metal into the depressions to fashion the source and drain electrodes contacting the photoresist, and removing the photoresist to produce the source and drain electrodes. According to one aspect, the single walled carbon nanotube channel connecting the source and drain electrode of step (b) is formed by depositing a photoresist above a portion of the semiconducting layer between and interconnecting the source electrode and drain electrode to create an exposed portion of the semiconducting later, and removing the exposed portion of the semiconducting layer to create the single walled carbon nanotube channel connecting the source and drain electrode. According to one aspect, the source electrode and drain electrode are altered by removing a portion of the source electrode and drain electrode extending to the edge of the substrate, wherein the step of removing a portion of the source electrode and drain electrode extending to the edge of the substrate is carried out by placing a photoresist on the single walled carbon nanotube channel and removing the portion of the source electrode and drain electrode extending to the edge of the substrate. According to one aspect, the single walled carbon nanotube channel be between 0.1 microns and 500 microns in length. According to one aspect, the single walled carbon nanotubes of the single walled carbon nanotube channel are at least 95% aligned. According to one aspect, the single walled carbon nanotube channel is functionalized to include a capture moiety cognate to a target analyte compound. According to one aspect, the single walled carbon nanotube channel is covalently functionalized to include a capture moiety cognate to a target analyte compound. According to one aspect, the single walled carbon nanotube channel is non-covalently functionalized to include a capture moiety cognate to a target analyte compound. According to one aspect, the semiconducting layer comprising single walled carbon nanotubes of step (a) is surface treated to improve photolithography of deposited photoresists. According to one aspect, the semiconducting layer comprising single walled carbon nanotubes of step (a) is surface treated with polymethyl glutarimide. According to one aspect, the semiconducting layer comprising single walled carbon nanotubes of step (a) is surface treated with polymethyl glutarimide to improve photolithography of deposited photoresists. According to one aspect, the semiconducting layer comprising single walled carbon nanotubes of step (a) is surface treated to decrease hydrophobicity. According to one aspect, the semiconducting layer comprising single walled carbon nanotubes of step (a) is surface treated with pyrene butyric acid. According to one aspect, the semiconducting layer comprising single walled carbon nanotubes of step (a) is surface treated with pyrene butyric acid to improve deposition of polymethyl glutarimide. According to one aspect, the forming of a source electrode and a drain electrode connecting a single walled carbon nanotube channel of step (b) uses a chromium or titanium adhesion layer. According to one aspect, a plurality of semiconducting single walled carbon nanotube channels with corresponding source and drain electrodes are formed on the substrate. According to one aspect, a plurality of semiconducting single walled carbon nanotube channels with corresponding source and drain electrodes are formed on the substrate in array format for multiplex analysis of a biological sample. According to one aspect, the biosensor device is attached to a probe.

Aspects of the present disclosure are directed to a biosensor device including (a) a semiconducting single walled carbon nanotube channel on the surface of a substrate, (b) a source electrode and a drain electrode connecting opposite ends of the semiconducting single walled carbon nanotube channel, (c) wherein the source electrode and the drain electrode are electrically connected in a manner to detect changes in current through the semiconducting single walled carbon nanotube channel in response to analyte in contact therewith. According to one aspect, the semiconducting single walled carbon nanotube channel is functionalized with a capture moiety cognate to a target analyte. According to one aspect, the semiconducting single walled carbon nanotube channel is functionalized with a plurality of capture moieties cognate to a plurality of target analytes. According to one aspect, the biosensor device is attached to a probe. According to one aspect, the biosensor device is removably attached to a probe. According to one aspect, the biosensor device is removably attached to a probe using magnetic force. According to one aspect, the biosensor device is removably attached to a probe using a male/female interconnect. According to one aspect, the biosensor device is attached to a TO header. According to one aspect, the biosensor device is attached to a printed circuit board. According to one aspect, the biosensor device is attached to a probe in a vertical fashion. According to one aspect, the biosensor device is attached to a probe in a horizontal fashion. According to one aspect, the biosensor device includes a removable protective layer attached to the semiconducting single walled carbon nanotube channel According to one aspect, a removable protective layer is attached to the semiconducting single walled carbon nanotube channel, wherein the removable protective layer is removed prior to use. According to one aspect, a removable protective layer is attached to the semiconducting single walled carbon nanotube channel, wherein the removable protective layer is a dissolvable thin film that is removed prior to use. According to one aspect, a removable protective layer is attached to the semiconducting single walled carbon nanotube channel, wherein the removable protective layer is a mechanically adhered thin film that is removed prior to use.

Aspects of the present disclosure include a device including a plurality of biosensors in series on a substrate, wherein each biosensor includes (a) an exposed semiconducting single walled carbon nanotube channel on the surface of a substrate, (b) a source electrode and a drain electrode connecting opposite ends of the exposed semiconducting single walled carbon nanotube channel, (c) wherein the source electrode and the drain electrode are electrically connected in a manner to detect changes in current through the exposed semiconducting single walled carbon nanotube channel in response to analyte in contact therewith, and wherein each biosensor is positioned on a probe for insertion into a well of a wellplate. According to one aspect, the plurality of biosensors are positioned vertically on the substrate. According to one aspect, the plurality of biosensors are positioned horizontally on the substrate. According to one aspect, at least one of the exposed semiconducting single walled carbon nanotube channels is functionalized with a capture moiety cognate to a target analyte. According to one aspect, each biosensor is removably attached to the substrate. According to one aspect, each biosensor is removably attached to a probe using magnetic force. According to one aspect, each biosensor is removably attached to a probe using a male/female interconnect. According to one aspect, each biosensor is attached to a TO header. According to one aspect, each biosensor is attached to a printed circuit board.

Aspects of the present disclosure include a method of detecting a target analyte in a biological sample including contacting the biological sample with a biosensor device including (a) an exposed semiconducting single walled carbon nanotube channel on the surface of a substrate, wherein the exposed semiconducting single walled carbon nanotube channel is functionalized with a capture moiety cognate to a target analyte, (b) a source electrode and a drain electrode connecting opposite ends of the exposed semiconducting single walled carbon nanotube channel, (c) wherein the source electrode and the drain electrode are electrically connected in a manner to detect changes in current through the exposed semiconducting single walled carbon nanotube channel in response to analyte in contact therewith, and detecting interaction between the target analyte and the exposed semiconducting single walled carbon nanotube channel by detecting changes in conductance of the exposed semiconducting single walled carbon nanotube channel According to one aspect, the biosensor device detects antibody-antibody interaction, protein-protein interaction, protein-peptide interaction, ligand-ligand interaction, nucleic acid-nucleic acid interaction. According to one aspect, binding and dissociation of a target analyte is detected. According to one aspect, a reference signal is compared to an analyte binding signal. According to one aspect, conductance is directly correlated with binding of the target analyte to the exposed semiconducting single walled carbon nanotube channel. According to one aspect, the biological sample acts as a gate between the source electrode and the gain electrode. According to one aspect, the biological sample acts as a gate between the source electrode and the gain electrode and gate voltage shift is directly correlated to target analyte interaction with the exposed semiconducting single walled carbon nanotube channel.

Aspects of the present disclosure are directed to a wafer substrate coated with a semiconducting single walled carbon nanotube layer, wherein the wafer substrate is annealed by heating and then surface treated with pyrene butyric acid.

Those having skill in the art, with the knowledge gained from the present disclosure, will recognize that various changes can be made to the disclosed apparatuses and methods in attaining these and other advantages, without departing from the scope of the present invention. As such, it should be understood that the features described herein are susceptible to modification, alteration, changes, or substitution. The specific embodiments illustrated and described herein are for illustrative purposes only, and not limiting of the invention as set forth in the appended claims. Other embodiments will be evident to those of skill in the art. It should be understood that the foregoing description is provided for clarity only and is merely exemplary. The spirit and scope of the present invention are not limited to the above examples, but are encompassed by the following claims. All publications and patent applications cited above are incorporated by reference in their entirety for all purposes to the same extent as if each individual publication or patent application were specifically and individually indicated to be so incorporated by reference.

What is claimed is:

1. A method of making a biosensor device comprising
(a) forming a semiconducting layer comprising single walled carbon nanotubes on the surface of a substrate,
(b) forming a source electrode and a drain electrode connecting a single walled carbon nanotube channel, and
(c) forming a dielectric window over a first portion of the source electrode and a first portion of the drain electrode while leaving a second portion of the source electrode, a second portion of the drain electrode and the single walled carbon nanotube channel exposed.

2. The method of claim 1 wherein the semiconducting layer comprising single walled carbon nanotubes of step (a) is formed by continuous, floating evaporative self-assembly or spin coating.

3. The method of claim 1 wherein the source electrode and drain electrode of step (b) is formed by
depositing a photoresist on the surface of the semiconducting layer,
photolithographically removing a portion of the photoresist to create depressions,
depositing a metal into the depressions to fashion the source and drain electrodes contacting the photoresist, and
removing the photoresist to produce the source and drain electrodes.

4. The method of claim 1 wherein the single walled carbon nanotube channel connecting the source and drain electrode of step (b) is formed by
depositing a photoresist above a portion of the semiconducting layer between and interconnecting the source electrode and drain electrode to create an exposed portion of the semiconducting later,
removing the exposed portion of the semiconducting layer to create the single walled carbon nanotube channel connecting the source and drain electrode.

5. The method of claim 1 wherein the single walled carbon nanotube channel be between 0.1 microns and 500 microns in length.

6. The method of claim 1 wherein the single walled carbon nanotubes of the single walled carbon nanotube channel are at least 95% aligned.

7. The method of claim 1 wherein the single walled carbon nanotube channel is functionalized to include a capture moiety cognate to a target analyte compound.

8. The method of claim 1 wherein the semiconducting layer comprising single walled carbon nanotubes of step (a) is surface treated to improve photolithography of deposited photoresists.

9. The method of claim 1 wherein the semiconducting layer comprising single walled carbon nanotubes of step (a) is surface treated to decrease hydrophobicity.

10. The method of claim 1 wherein the semiconducting layer comprising single walled carbon nanotubes of step (a) is surface treated with pyrene butyric acid.

11. The method of claim 1 wherein a plurality of semiconducting single walled carbon nanotube channels with corresponding source and drain electrodes are formed on the substrate.

12. The method of claim 1 wherein a plurality of semiconducting single walled carbon nanotube channels with corresponding source and drain electrodes are formed on the substrate in array format for multiplex analysis of a biological sample.

13. The method of claim 1 wherein the biosensor device is attached to a probe.

14. A biosensor device comprising
(a) a semiconducting single walled carbon nanotube channel on the surface of a substrate,
(b) a source electrode and a drain electrode connecting opposite ends of the semiconducting single walled carbon nanotube channel,
(c) wherein the source electrode and the drain electrode are electrically connected in a manner to detect changes in current through the semiconducting single walled carbon nanotube channel in response to analyte in contact therewith.

15. The biosensor device of claim 14 wherein the semiconducting single walled carbon nanotube channel is functionalized with a capture moiety cognate to a target analyte.

16. The biosensor device of claim 14 wherein the semiconducting single walled carbon nanotube channel is functionalized with a plurality of capture moieties cognate to a plurality of target analytes.

17. The biosensor device of claim 14 being attached to a probe.

18. The biosensor device of claim 14 being removably attached to a probe.

19. The biosensor device of claim 14 being removably attached to a probe using magnetic force.

20. The biosensor device of claim 14 being removably attached to a probe using a male/female interconnect.

21. The biosensor device of claim 14 being attached to a printed circuit board.

22. The biosensor device of claim 14 wherein a removable protective layer is attached to the semiconducting single walled carbon nanotube channel

23. A device comprising a plurality of biosensors in series on a substrate, wherein each biosensor includes
(a) an exposed semiconducting single walled carbon nanotube channel on the surface of a substrate,
(b) a source electrode and a drain electrode connecting opposite ends of the exposed semiconducting single walled carbon nanotube channel,
(c) wherein the source electrode and the drain electrode are electrically connected in a manner to detect changes in current through the exposed semiconducting single walled carbon nanotube channel in response to analyte in contact therewith, and
wherein each biosensor is positioned on a probe for insertion into a well of a wellplate.

24. The device of claim 23 wherein the plurality of biosensors are positioned vertically on the substrate.

25. The device of claim 23 wherein the plurality of biosensors are positioned horizontally on the substrate.

26. The device of claim 23 wherein at least one of the exposed semiconducting single walled carbon nanotube channels is functionalized with a capture moiety cognate to a target analyte.

27. The device of claim 23 wherein each biosensor is removably attached to the substrate.

28. The device of claim 23 wherein each biosensor is removably attached to a probe using magnetic force.

29. The device of claim 23 wherein each biosensor is removably attached to a probe using a male/female interconnect.

30. The device of claim 23 wherein each biosensor is attached to a printed circuit board.

31. A method of detecting a target analyte in a biological sample comprising
contacting the biological sample with a biosensor device including
(a) an exposed semiconducting single walled carbon nanotube channel on the surface of a substrate, wherein the exposed semiconducting single walled carbon nanotube channel is functionalized with a capture moiety cognate to a target analyte,
(b) a source electrode and a drain electrode connecting opposite ends of the exposed semiconducting single walled carbon nanotube channel,
(c) wherein the source electrode and the drain electrode are electrically connected in a manner to detect changes in current through the exposed semiconducting single walled carbon nanotube channel in response to analyte in contact therewith, and
detecting interaction between the target analyte and the exposed semiconducting single walled carbon nanotube channel by detecting changes in conductance of the exposed semiconducting single walled carbon nanotube channel.

32. The method of claim 31 wherein the biosensor device detects antibody-antibody interaction, protein-protein interaction, protein-peptide interaction, ligand-ligand interaction, nucleic acid-nucleic acid interaction.

33. The method of claim 31 where binding and dissociation of a target analyte is detected.

34. The method of claim 31 where a reference signal is compared to an analyte binding signal.

35. The method of claim 31 wherein conductance is directly correlated with binding of the target analyte to the exposed semiconducting single walled carbon nanotube channel.

36. The method of claim 31 wherein the biological sample acts as a gate between the source electrode and the gain electrode.

37. The method of claim 31 wherein the biological sample acts as a gate between the source electrode and the gain electrode and gate voltage shift is directly correlated to target analyte interaction with the exposed semiconducting single walled carbon nanotube channel.

38. A wafer substrate coated with a semiconducting single walled carbon nanotube layer, wherein the wafer substrate is annealed by heating and then surface treated with pyrene butyric acid.
